(19) United States
(12) Patent Application Publication
(10) Pub. No.: US 2025/0342542 A1
(43) Pub. Date: Nov. 6, 2025

(54) COLLABORATIVE ORDER COORDINATION AND PROCESSING

(71) Applicant: Comida Solutions, Inc., Folsom, CA (US)

(72) Inventors: Larry Robinson, Folsom, CA (US); Loren Froomin, Loomis, CA (US)

(73) Assignee: Comida Solutions, Inc., Folsom, CA (US)

(21) Appl. No.: 19/196,531

(22) Filed: May 1, 2025

Related U.S. Application Data
(60) Provisional application No. 63/641,323, filed on May 1, 2024.
(60) Provisional application No. 63/641,330, filed on May 1, 2024.

(51) Int. Cl. G06Q 50/12; G06Q 20/14; G06Q 30/0601; H04W 4/021

(52) U.S. Cl. CPC G06Q 50/12; G06Q 20/14; G06Q 30/0641; H04W 4/021; G06Q 30/0603

(57) ABSTRACT

Systems, devices, and methods for coordinating and processing a collaborative order are provided. An Order Processing System (OPS) monitors a geofenced area around a physical location of a dining entity. If there are at least two communication devices of members of a group present within the geofenced area, the OPS prompts the members to join a collaborative order via their communication devices. The OPS establishes a group session for the collaborative order based on an acceptance of the prompt. The OPS renders a Digital Menu Interface (DMI) of the dining entity on each communication device and synchronizes multiple activities on the DMI into the collaborative order during the group session. The OPS generates a bill associated with the collaborative order on the DMI and splits the bill among one or more members of the group based on a selection of a customizable payment option provided by the OPS.

### CROSS-REFERENCE TO RELATED APPLICATIONS

This application claims priority to U.S. Provisional Application No. 63/641,323 filed May 1, 2024 and U.S. Provisional Application No. 63/641,330, filed May 1, 2024, the entirety of which is incorporated herein by reference.

### FIELD

The present disclosure relates to online order processing. More particularly, the present disclosure relates to collaborative order coordination and processing.

### BACKGROUND

The advent and widespread adoption of mobile technology, for example, smartphone technology, have substantially transformed the way users interact with various services, including dining-related services. For example, mobile applications (apps) such as smartphone apps may be utilized by individual users and groups alike to place orders at dining entities such as restaurants, food service providers, or the like. Through such apps, users can conveniently browse menus, place orders, and make payments, all without the need for conventional in-person interactions or physical menus. These apps cater to users seeking time savings, efficiency, control, and personalization in their dining experience.

Despite these advancements, challenges persist, particularly in group dining scenarios. When ordering as a group, particularly a group including members with varying dietary needs, preferences, or restrictions, coordinating and communicating such information accurately can be problematic. Conventional group ordering methods often rely on a single intermediary or require the members of the group to manually coordinate their preferences through third-party apps, for example, calling apps, messaging apps, group chats, or the like, resulting in a fragmented and error-prone process. Changes to individual orders may be difficult to track and update in real time, and splitting the total cost of an order among the members of the group can further complicate the process. These inefficiencies can hinder the overall dining experience and detract from the group's social engagement. Conventional group ordering methods lack a unified solution for seamlessly managing individual preferences, updates, and payments within a group context, thereby increasing chances of miscommunication, oversight, and logistical complexity.

Further, the use of smartphone apps to place orders for pickup has introduced further operational challenges for both customers and dining entities. For example, there may be inefficiencies in synchronizing a timing of a preparation or a completion of an order with an actual time of arrival of a customer for the pickup of the order. If the order is completed prematurely, dining items such as food items, beverage items, or the like, may not maintain their intended temperature, texture, or freshness by the time the customer arrives, resulting in diminished quality and customer dissatisfaction. Moreover, delays in the preparation of the dining items due to a lack of visibility into the time of arrival of the customer may cause bottlenecks, particularly during peak hours at a dining entity such as a restaurant, which may lead to service delays, order backlogs, and increased pressure on kitchen staff, adversely affecting other areas of restaurant operations, including dine-in and other takeout services. In delivery or curbside pickup scenarios, failure to synchronize order readiness with the time of arrival of the customer can further disrupt the customer's plans and compromise the intended convenience of dining-related services.

### SUMMARY OF THE DISCLOSURE

Systems, devices, and methods for coordinating and processing a collaborative order are provided. In many embodiments, a system comprising one or more processors, a memory communicatively coupled to the one or more processors, and an order processing logic configured to coordinate and process a collaborative order is provided. The memory comprises the order processing logic that is configured to monitor a geofenced area around a physical location of a dining entity. In response to a presence of at least two communication devices of a plurality of members of a group within the monitored geofenced area, the order processing logic is further configured to prompt the plurality of members to join a collaborative order via the at least two communication devices. The order processing logic is further configured to establish a group session for the collaborative order based on an acceptance of the prompt on the at least two communication devices, render a digital menu interface of the dining entity on each communication device of the at least two communication devices, and synchronize a plurality of activities on the rendered digital menu interface into the collaborative order during the group session.

In a number of embodiments, the order processing logic is further configured to receive at least two versions of a menu of the dining entity, identify at least one difference between the received at least two versions of the menu of the dining entity, and update the digital menu interface based on the identified at least one difference.

In a variety of embodiments, the order processing logic is further configured to execute a comparative analysis functionality implemented by a menu definition language for the identification of the at least one difference between the received at least two versions of the menu of the dining entity.

In various embodiments, the order processing logic is further configured to render a plurality of dining items in a catalog format on corresponding dining cards on a menu section of the digital menu interface.

In more embodiments, in response to a selection of a dining item of the plurality of dining items in the menu section, the order processing logic is further configured to expand and execute at least one customization on a dining card associated with the dining item on the digital menu interface, free of navigating away from the menu section.

In additional embodiments, the digital menu interface comprises an order screen configured to integrate a set of dining items ordered by the plurality of members of the group during the group session and provide a plurality of customization options for the collaborative order.

In further embodiments, the plurality of activities comprises at least one of: selecting one or more dining items offered by the dining entity, modifying the one or more dining items, issuing one or more requests, and executing one or more payments from the plurality of members of the group.

In still more embodiments, the order processing logic is further configured to reflect an update of at least one activity of the plurality of activities instantaneously on the at least two communication devices of the plurality of members of the group during the group session.

In still further embodiments, the synchronization of the plurality of activities on the rendered digital menu interface into the collaborative order during the group session is in one of real time or near-real time.

In still additional embodiments, the order processing logic is further configured to store activity data of the plurality of activities in a cloud storage system during the group session.

In some more embodiments, the order processing logic is further configured to delete a subset of the activity data from the cloud storage system based on a communication device of the at least two communication devices exiting the group session, wherein the subset of the activity data is associated with the communication device.

In yet various embodiments, the order processing logic is further configured to generate a bill associated with the collaborative order on the digital menu interface, provide one or more customizable payment options associated with the bill on the digital menu interface, split the bill among one or more members of the plurality of members of the group based on a selection of a customizable payment option of the one or more customizable payment options, and reflect an update to the bill instantaneously on the at least two communication devices of the plurality of members of the group via the digital menu interface based on the split.

In yet more embodiments, the order processing logic is further configured to transmit at least one promotional element to the at least two communication devices of the plurality of members of the group based on configurable criteria.

In still yet more embodiments, the configurable criteria for transmitting at least one promotional element to the at least two communication devices of the plurality of members of the group comprise at least one of: geolocation data, one or more preferences, or one or more behavioral elements of the plurality of members of the group.

In many further embodiments, the order processing logic is further configured to: generate a preference profile of at least one member of the plurality of members of the group; and dynamically generate at least one personalized dining recommendation based on at least one of the preference profile or configurable criteria.

In many additional embodiments, the configurable criteria for dynamically generating at least one personalized dining recommendation comprise at least one of: a social circle of the at least one member of the plurality of members of the group, location data, time, one or more social influencing elements, a reputation, a rating, one or more preferences, one or more behavioral elements, order data associated with the collaborative order, activity data associated with the plurality of activities on the rendered digital menu interface, one or more reviews, one or more events, or one or more attractions proximal to the dining entity.

In still yet further embodiments, the order processing logic is further configured to render a compass element pointing to a line of sight associated with the physical location of the dining entity, on a graphical user interface of a communication device of the at least two communication devices in response to a presence of the communication device within the monitored geofenced area.

In still yet additional embodiments, the memory comprises an order processing logic that is configured to execute a placement of an order for pickup, with a dining entity, monitor a geofenced area around a physical location of the dining entity, determine an estimated time of the pickup of the order in response to a presence of a communication device associated with the pickup of the order within the monitored geofenced area, and prompt the dining entity regarding the estimated time of the pickup of the order.

In several embodiments, the order processing logic is further configured to automatically trigger one or more notifications associated with the pickup of the order to the communication device based on the estimated time of the pickup.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which an order processing logic may operate on a plurality of devices for coordinating and processing a collaborative order in accordance with various embodiments of the disclosure;

FIG. 2 is an environment including an order processing system for coordinating and processing a collaborative order in accordance with various embodiments of the disclosure;

FIG. 3 is a schematic diagram illustrating establishment of a group session and synchronization of activities during the group session in accordance with various embodiments of the disclosure;

FIG. 4 is a schematic diagram illustrating group fungibility in accordance with various embodiments of the disclosure;

FIG. 5 is a representation of a communication device illustrating a digital menu interface for placement of a collaborative order in accordance with various embodiments of the disclosure;

FIG. 6 is a representation of a communication device illustrating a digital menu interface for payment of a collaborative order in accordance with various embodiments of the disclosure;

FIG. 7 is a schematic diagram illustrating payment processing for an order in accordance with various embodiments of the disclosure;

FIGS. 8A-8E are representations of communication devices illustrating a digital menu interface for splitting a bill associated with a collaborative order in accordance with various embodiments of the disclosure;

FIG. 9 is a schematic diagram illustrating synchronization of a completion of an order with an estimated time of a pickup of the order in accordance with various embodiments of the disclosure;

FIG. 10 is a schematic diagram illustrating an example neural network in accordance with various embodiments of the disclosure;

FIG. 11 is a representation of a communication device illustrating a graphical user interface displaying a list of personalized recommendations of dining entities with compass elements pointing to physical locations of the dining entities in accordance with various embodiments of the disclosure;

FIG. 12 is a schematic diagram illustrating an instantaneous update of content of a menu on a digital menu interface in accordance with various embodiments of the disclosure;

FIG. 13 is a schematic diagram illustrating customer remediation through digital credits in accordance with various embodiments of the disclosure;

FIG. 14 is a flowchart depicting a process for coordinating and processing a collaborative order in accordance with various embodiments of the disclosure;

FIG. 15 is a flowchart depicting a process for facilitating splitting of a bill associated with a collaborative order in accordance with various embodiments of the disclosure;

FIG. 16 is a flowchart depicting a process for facilitating a completion of an order based on an estimated time of a pickup of the order in accordance with various embodiments of the disclosure; and

FIG. 17 is a conceptual block diagram of a system suitable for configuration with an order processing logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. In addition, common, but well-understood, elements that are useful or necessary in a commercially feasible embodiment are often not depicted to facilitate a less obstructed view of these various embodiments of the present disclosure.

### DETAILED DESCRIPTION

In response to the issues described above, systems, devices, and methods are discussed herein for coordinating and processing a collaborative order. A collaborative order may refer to an order placed through cooperation and coordination between at least two members of a group, herein referred to as “group members.” The group members may, for example, be customers or diners such as family members, colleagues, friends, teams, tourists, students, event attendees, or the like, who wish to dine together as a group. A customer may refer to an individual user, a group designate, or a member of a group who may order and pay for dining items, for example, food items, beverage items, or the like, either by dining in at a dining entity, ordering dining items for pickup at the dining entity, or utilizing an online platform for delivery of dining items. The dining entity may refer to an establishment or an organization whose primary function is to prepare and serve dining items to customers for on-site consumption, takeout, pickup, or delivery. Examples of the dining entity may include a restaurant, a café, a food court, a food truck, a canteen, any food service provider, a beverage provider, or the like.

Despite advancements in the utilization of mobile technology, for example, smartphone technology, for placing orders at dining entities, challenges persist in group dining scenarios. When ordering as a group, particularly a group including members with varying dietary needs, preferences, or restrictions, coordinating and communicating such information accurately can be problematic. Conventional group ordering methods often rely on a single group member or designate or require all the group members to manually coordinate their preferences through third-party applications (apps), for example, calling apps, messaging apps, group chats, or the like, resulting in a fragmented and error-prone process. Changes to individual orders may be difficult to track and update in real time, and splitting the total cost of a collaborative order among the group members can further complicate the process. These inefficiencies can hinder the overall dining experience and detract from the group's social engagement. Conventional group ordering methods lack a unified solution for seamlessly managing individual preferences, updates, and payments within a group context, thereby increasing chances of miscommunication, oversight, and logistical complexity.

Further, the use of smartphone apps to place orders for pickup has introduced further operational challenges for both dining entities and customers, for example, individual users, group designates, delivery personnel, or the like. For example, there may be inefficiencies in synchronizing a timing of a preparation or a completion of an order with an actual time of arrival of a customer for the pickup of the order. If the order is completed prematurely, the dining items may not maintain their intended temperature, texture, or freshness by the time the customer arrives, resulting in diminished quality and customer dissatisfaction. Moreover, delays in the preparation of the dining items due to a lack of visibility into the time of arrival of the customer may cause bottlenecks, particularly during peak hours at a dining entity such as a restaurant, which may lead to service delays, order backlogs, and increased pressure on kitchen staff, adversely affecting other areas of restaurant operations, including dine-in and other takeout services. In delivery or curbside pickup scenarios, failure to synchronize order readiness with the time of arrival of the customer can further disrupt the customer's plans and compromise the intended convenience of dining-related services.

The present disclosure addresses the above-mentioned challenges by providing systems, devices, and methods for coordinating and processing a collaborative order. The embodiments described herein can include one or more order processing systems enhanced with geofencing technology for group dining scenarios, providing seamless order coordination and pickup arrangements. Geofencing may refer to a location-based technology that creates a virtual boundary or perimeter around a real-world geographical area by utilizing various location-based services, for example, a Global Positioning System (GPS) service, a Radio Frequency Identification (RFID) service, a Wi-Fi® service of Wi-Fi Alliance Corporation, a cellular service, or the like. The virtual boundary or perimeter, herein referred to as a “geofence,” may, for example, be a circle with a configurable radius around a point such as a physical location of a dining entity, or a polygon with multiple points forming the geofence. In many embodiments, the geofence may be a route of any shape drawn on a map by utilizing software or platforms. Geofencing may allow dining entities to define geofences around their physical locations, thereby facilitating targeted interactions with group members based on their proximity. In group dining scenarios, the embodiments herein may utilize geofencing within an order processing system to allow the group members to effortlessly synchronize their orders and streamline pickup logistics. As the group members approach a designated geofenced area of a dining entity, the order processing system can prompt the group members, via their communication devices, for example, smartphones, to join a collaborative order, facilitating collaborative decision-making and ensuring that preferences of all the group members are accounted for. By coordinating and processing the collaborative order, the order processing system may eliminate the need for manual coordination or reliance on third-party apps and external messaging platforms, reducing chances of confusion, miscommunication, oversight, and logistical complexity, while minimizing delays in an ordering process.

Moreover, in a number of embodiments, the order processing system may leverage geofencing to optimize order pickup arrangements, enhancing convenience and efficiency for the group members. In a variety of embodiments, once orders are placed and prepared, the order processing system can automatically trigger notifications to the communication devices of the group members as they enter the geofence of the dining entity, prompting the group members, via their communication devices, to proceed to a designated pickup area. By synchronizing the timing of readiness of the collaborative order with the group members' proximity to the dining entity, the order processing system may minimize wait times and ensure that dining items are served fresh and promptly upon arrival of the group members. Further, geofencing technology may provide opportunities for personalized engagement and targeted promotions within group dining contexts. In various embodiments, the order processing system can utilize geolocation data and order data to assist dining entities in tailoring promotional elements including, for example, offers, incentives, or the like, based on preferences and behaviors of the group members, thereby enhancing customer satisfaction and driving repeat business. For example, through the order processing system, a restaurant may offer exclusive discounts to groups that place collaborative orders within a certain radius of the restaurant or provide customized dining recommendations based on nearby attractions or events.

Further, the rise of mobile technology has transformed how customers explore dining options, with mobile search providing instant access to a plethora of choices. As conventional menus may be unable to adapt to a mobile format, often resulting in a cumbersome customer experience, in more embodiments, recognizing a need for modernization, the order processing system may implement a menu management system configured to provide a unified solution for creating and managing digital menus. In additional embodiments, the menu management system may implement a Menu Definition Language (MDL) to facilitate the creation and management of digital menus. In further embodiments, the menu management system may utilize the MDL to create digital menus by mirroring the structure and language of conventional menus, allowing users with minimal technical knowledge to effortlessly craft mobile-friendly versions of the digital menus. The MDL may implement an intuitive design to allow the users to replicate natural language constructs such as bulleted lists and customizable modifiers, streamlining tasks and reducing their complexity. Moreover, the MDL may support diverse input methods, ensuring accessibility and efficiency across various content creation modalities. In still more embodiments, the MDL may include a comparative analysis functionality configured to identify differences between alternative versions of a menu. The comparative analysis functionality may allow dining entities to tailor their offerings across different service channels or adapt their digital menus dynamically in response to market demands. By automating the versioning process, the MDL may ensure that digital menus remain current and contextually relevant, enhancing both the dining experience for the customers and operational workflows for the dining entities.

Furthermore, the integration of mobile technology into the dining experience has transformed how individual users explore, evaluate, and share their culinary adventures. While a conventional discovery of dining entities may rely on physical proximity and peer referrals, the emergence of digital platforms ushered in a new era of online reviews and recommendations. In still further embodiments, the order processing system may implement a personalized recommendation system configured to leverage user-generated data and advanced algorithms to generate and render dynamic and personalized dining suggestions or recommendations tailored to individual preferences. The personalized recommendation system may capture and analyze choices of dining items and feedback from customers to generate detailed preference profiles of their dining preferences. By discerning patterns and preferences, the personalized recommendation system may deliver tailored dining recommendations associated with dining entities and dining items. In still additional embodiments, the personalized recommendation system may integrate other criteria including, for example, social circles of the customers into the recommendation process, broadening the scope of the personalized dining recommendations to include endorsements from members of their social circles such as trusted family, friends, influencers, or the like.

In some more embodiments, the personalized recommendation system may be integrated with geographical adaptability to dynamically adjust the personalized dining recommendations based on a customer's location. As customers travel, the personalized recommendation system may incorporate local tastes and preferences into the customer's preference profile, providing an optimized dining experience regardless of geographical boundaries. Furthermore, the personalized recommendation system may implement Artificial Intelligence (AI) to generate personalized dining recommendations of pairings between the dining items, for example, beverage pairings with food items, thereby adding a supplementary layer of personalization and enhancing the overall dining experience. In yet various embodiments, the personalized recommendation system may implement a user-driven query feature, empowering customers to receive customized offers from dining entities, while also aiding the dining entities in optimizing their capacity through targeted incentives. In yet more embodiments, the personalized recommendation system may provide a platform for sharing dining experiences between users such as social influencers and their followers, fostering a symbiotic relationship between the followers seeking authentic dining recommendations and the social influencers seeking to extend their impact. The personalized recommendation system may, therefore, provide a significant advancement in generating personalized, dynamic, and socially integrated dining recommendations, reshaping the digital landscape of culinary exploration and enjoyment.

In response to the growing emphasis on digital engagement and customer experience in the dining industry, in still yet more embodiments, the order processing system may provide a client application, for example, a mobile application, deployable on a customer's communication device for streamlining browsing of a digital menu and placement of an order. In many further embodiments, the client application may include a digital menu interface that amalgamates all digital menus and sections of a corresponding dining entity into a singular, easily navigable format on a landing page. In many additional embodiments, the digital menu interface may allow customers to scroll the digital menu in one or more of a vertical direction and a horizontal direction, swiftly scanning dining items displayed in a catalog format on dining cards, thereby allowing improved decision-making for the customers and offering a comprehensive overview of offerings of the dining entity in an aesthetically pleasing manner, enhancing the customer's browsing experience. In still yet further embodiments, the digital menu interface may be configured as a centralized and intuitive interface that allows group members to collaboratively input and convey diverse dietary preferences directly to a dining entity. The digital menu interface may not only streamline communication and reduce the potential for error, but also enhance the dining experience for group members with special dietary requirements. Furthermore, the digital menu interface may promote a more inclusive and accommodating dining culture, reflecting the increasing demand for personalized and respectful dining service across diverse populations. In still yet additional embodiments, upon receiving a selection of one or more dining items on the corresponding dining card(s) via a menu section of the digital menu interface, the order processing system may render larger dining cards arranged, for example, in a vertical list, with focus centered on the selected dining item(s) from the menu section. The larger dining cards arranged in the vertical list may allow for further exploration and customization of the selected dining item(s) without the customer having to navigate away from the menu section, thereby reducing the complexity associated with the ordering process. Through the digital menu interface of the client application, the order processing system may allow customers to conveniently customize the dining items directly on the larger dining cards, eliminating the need to navigate through multiple screens or intricate options, thereby enhancing customer satisfaction and efficiency.

Further, in several embodiments, the digital menu interface may further include an order screen onto which the selected dining items are seamlessly integrated, thereby consolidating orders from other group members who may be seated at the same table into a single collaborative order. This order screen may be configured to facilitate swift modifications such as adding, removing, copying, or changing dining items of the collaborative order, thereby substantially improving the dining experience. In several more embodiments, the client application, in communication with the order processing system, may prioritize the presentation and exploration of the dining items via the digital menu interface, encouraging group members to discover and consider dining items that they may not have noticed otherwise, potentially boosting sales and enriching the dining experience. Furthermore, in numerous embodiments, the client application may provide support for varied dining item descriptions, images, and sequences to empower the dining entities to conduct A/B testing, optimizing menu layouts and descriptions to maximize sales revenue, thereby offering valuable tools for enhancing service offerings and operational efficiency.

In numerous additional embodiments, the systems, devices, and methods discussed herein may integrate payments and payment equivalents into the ordering process, further streamlining group dining experiences. In further additional embodiments, the order processing system may implement an advanced digital payment system comprising one or more customizable payment options associated with a bill associated with the collaborative order on the digital menu interface. The advanced digital payment system may be configured to split the bill among one or more group members based on a selection of one of the customizable payment options. The advanced digital payment system may allow the group members to effortlessly split the total cost of the collaborative order on the bill based on individual dining items or the total bill. The advanced digital payment system may, therefore, eliminate the difficulty of calculating individual amounts and exchanging cash or dealing with separate checks or cards, providing a seamless and convenient payment solution for the group members.

The systems, devices, and methods discussed herein may offer a myriad of benefits in group dining scenarios, for example, where group members can independently select their desired dining items and share them with the group. Moreover, through the digital menu interface, the order processing system may foster inclusivity by accommodating various dietary restrictions and preferences within the group. Whether a group member follows a specific diet, has food allergies, or merely prefers certain ingredients, the digital menu interface may empower the group members to communicate their needs directly to the dining entity through the collaborative order without the risk of miscommunication or oversight, thereby enhancing the dining experience for the group members with special dietary requirements and promoting a more inclusive and accommodating dining culture overall. Further, in many embodiments, the order processing system may extend the integration of technology beyond the ordering process through the advanced digital payment system by empowering the group members to effortlessly split the bill associated with the collaborative order among themselves, automatically tracking each group member's share of the bill, and update individual or group totals in real time or near-real time. Furthermore, in a number of embodiments, the order processing system may extend the integration of technology beyond the ordering process through the personalized recommendation system. In a variety of embodiments, the personalized recommendation system may provide loyalty programs, personalized recommendations, and exclusive promotions, further incentivizing the group members to engage with their brand digitally. This symbiotic relationship between technology and dining entities may not only enhance diner satisfaction and loyalty but also provide valuable data insights that the dining entities can leverage to optimize their operations and offerings.

Aspects of the present disclosure may be embodied as an apparatus, a system, a method, or a computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” a “module,” an “apparatus,” or a “system.” Furthermore, aspects of the present disclosure may take the form of a computer program product embodied in one or more non-transitory computer-readable storage media storing computer-readable and/or executable program code. Many of the functional units described in this specification have been labeled as functions, to emphasize their implementation independence more particularly. For example, a function may be implemented as a hardware circuit comprising custom Very Large Scale Integration (VLSI) circuits or gate arrays, off-the-shelf semiconductors such as logic chips, transistors, or other discrete components. A function may also be implemented in programmable hardware devices such as via field-programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, a procedure, or a function. Nevertheless, the executables of an identified function need not be physically located together but may comprise disparate instructions stored in different locations which, when joined logically together, comprise the function and achieve the stated purpose for the function.

A function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, an apparatus, a processor, or a device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or a server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field-programmable gate arrays, programmable array logic, programmable logic devices, or the like. A component may comprise one or more silicon integrated circuit devices (e.g., chips, die, die planes, packages, or the like) or other discrete electrical devices, in electrical communication with one or more other components through electrical lines of a Printed Circuit Board (PCB) or the like. Each of the functions and/or modules described herein, in more embodiments, may alternatively be embodied by or implemented as a component.

A circuit, as used herein, comprises a set of one or more electrical and/or electronic components providing one or more pathways for electrical current. In additional embodiments, a circuit may include a return pathway for electrical current, so that the circuit is a closed loop. In further embodiments, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In still more embodiments, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field-programmable gate array, a programmable array logic, a programmable logic device, or the like (e.g., as firmware, a netlist, or the like). A circuit may comprise one or more silicon integrated circuit devices (e.g., chips, die, die planes, packages, or the like) or other discrete electrical devices, in electrical communication with one or more other components through electrical lines of a PCB or the like. Each of the functions and/or modules described herein, in still further embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Furthermore, the terms “or” and “and/or” as used herein are to be interpreted as inclusive or meaning any one or any combination. Therefore, “A, B, or C” or “A, B, and/or C” means “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

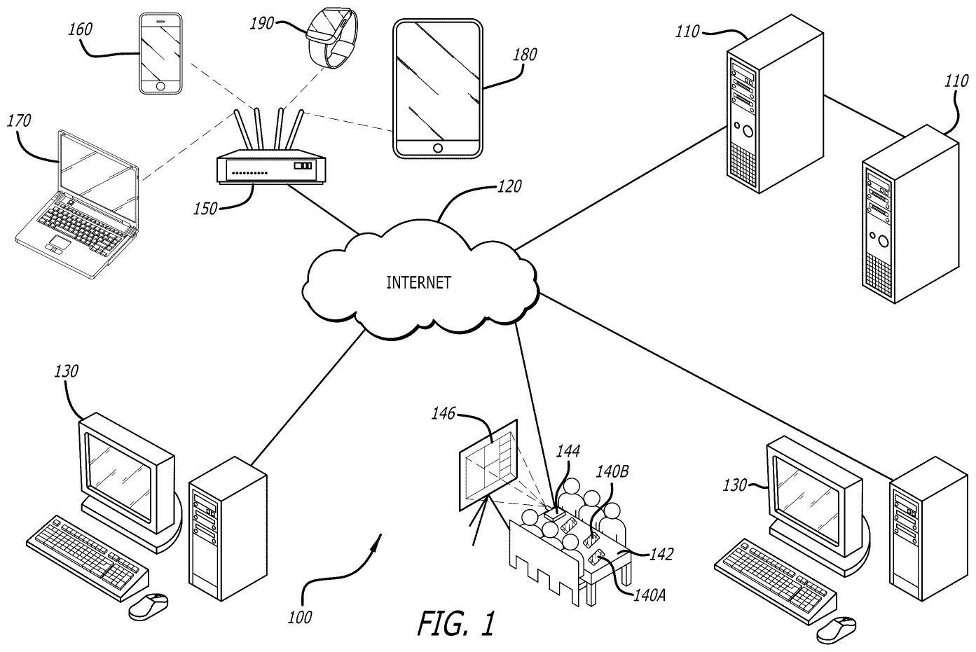

Referring to FIG. 1, a conceptual network diagram 100 of various environments in which an order processing logic may operate on a plurality of devices for coordinating and processing a collaborative order in accordance with various embodiments of the disclosure is shown. Those skilled in the art will recognize that the order processing logic can include various hardware and/or software deployments and can be configured in a variety of ways. In many embodiments, the order processing logic can be configured as a standalone device, exist as a logic in another computing device, be distributed among various computing devices operating in tandem, or be remotely operated as part of a cloud-based system. In a number of embodiments, one or more order processing servers 110 can be configured with the order processing logic or can otherwise operate as the order processing logic. In a variety of embodiments, the order processing logic may operate on one or more order processing servers 110 connected to a communication network 120 (shown as the “Internet 120”). The Internet 120 can include wired networks or wireless networks. In various embodiments, the order processing logic can be provided as a cloud-based service that can service remote networks, such as, but not limited to a deployed network. In more embodiments, the order processing logic may be operated as a distributed logic across multiple computing devices.

In additional embodiments, the order processing logic operating in one or more of the devices may be configured to transmit and receive data related to providing, recording, and processing collaborative orders between customers and dining entities, for example, restaurants, cafés, food courts, food trucks, canteens, or the like. In further embodiments, the order processing servers 110 can be configured to transmit a variety of data across the Internet 120 to any number of computing devices or communication devices such as, but not limited to, personal computers 130, group ordering devices, for example, 140A, 140B, and 140C (referenced as “140A-140C”), and mobile computing devices including, for example, cellular phones 160, laptop computers 170, portable tablet computers 180, wearable computing devices 190, or the like (referenced as “170-190”). In the embodiment depicted in FIG. 1, the mobile computing devices 170-190 are connected wirelessly to the Internet 120 via a wireless network access point 150. In still more embodiments, a personal computer 130 may be utilized to access and/or manage various aspects of the order processing logic, either remotely or within a network itself. In the embodiment depicted in FIG. 1, the personal computer 130 communicates over the Internet 120 and can access the order processing logic of the order processing servers 110. In still further embodiments, order data may be mirrored or otherwise supplemented in additional cloud-based service provider servers or edge network systems. In various embodiments, the order processing servers 110 can be hosted as virtual servers within a cloud-based service. In still additional embodiments, transmitting and receiving order data can occur over the Internet 120 through wired and/or wireless connections. It should be understood by those skilled in the art that the types of wired and/or wireless connections between the devices may incorporate any combination of devices and connections as needed.

In some more embodiments, the order processing logic may process order data including, for example, text data, audio data, video data, or the like, from members of a group, herein referred to as “group members,” via the personal computers 130, the group ordering devices 140A-140C, and/or the mobile computing devices 170-190. In these embodiments, based on one or more thresholds or other network conditions/configurations, the order data may need to be transmitted to other devices for processing a collaborative order. This may require determining the quantity, quantity, or context of the collaborative order. Order processes that have a certain configuration can be established. Based upon this configuration, various order or other attribute data can be collected. Based on these changes during an order process, the amount of data transmitted can be optimized for better and/or more accurate and/or faster processing.

By way of a non-limiting example, the embodiments herein are described in the context of the order processing logic operating in one or more of the order processing servers 110 for coordinating and processing a collaborative order between group members seated at a table 142 in a restaurant. In this example scenario, the order processing logic may prompt the group members to join the collaborative order via their group ordering devices 140A-140C. In yet various embodiments, the group members may receive the prompt via a client application deployed on each of the group ordering devices 140A-140C. In yet more embodiments, the order processing logic may facilitate creation of a geofenced area around a physical location of the restaurant by utilizing geofencing Application Programming Interfaces (APIs), third-party geofencing platforms, Software Development Kits (SDKs), or the like. In still yet more embodiments, the order processing logic may facilitate creation of a geofenced area around the physical location of the restaurant using location-based or proximity-based technologies such as Global Positioning System (GPS) coordinates, a Wi-Fi® communication protocol, or a Bluetooth® communication protocol of Bluetooth Sig, Inc. In the above example scenario, the order processing logic may facilitate creation of a geofenced area around the table 142 of the restaurant. In these embodiments, the order processing logic may monitor the created geofenced area around the table 142. In many further embodiments, the order processing logic may monitor and track a presence of the group ordering devices 140A-140C through the client application installed on each of the group ordering devices 140A-140C. To allow tracking of each of the group ordering devices 140A-140C, the client application may enable location services on each of the group ordering devices 140A-140C, provide permissions to track the location of each of the group ordering devices 140A-140C, and allow receipt of notifications from the order processing logic, based on consent received from the group members. In many additional embodiments, when a group ordering device, for example, any of the group ordering devices 140A-140C, enters the geofenced area around the table 142, the client application may detect this entry event using the GPS or network data of the group ordering device and transmit the entry event to the order processing server(s) 110 that executes the order processing logic. The entry event may indicate the presence of the group ordering device to the order processing logic. In response to the presence of the group ordering devices 140A-140C within the monitored geofenced area, the order processing logic may prompt the group members to join the collaborative order via the group ordering devices 140A-140C.

The order processing logic may establish a group session for the collaborative order based on an acceptance of the prompt on the group ordering devices 140A-140C. The order processing logic may render a digital menu interface of the restaurant on the client application deployed on each of the group ordering devices 140A-140C. In still yet further embodiments, the order processing logic may render the digital menu interface 146 for display on a display device 148, via a projector 144 disposed on the table 142. The digital menu interface may display a list of dining items, for example, food items, beverage items, or the like, for selection by the group members via their group ordering devices 140A-140C. The order processing logic may synchronize multiple activities on the digital menu interface into the collaborative order during the group session in real time or near-real time. The activities may include, for example, selecting one or more dining items offered by the restaurant, modifying the dining item(s), issuing one or more requests, executing one or more payments from the group members, or the like. In still yet additional embodiments, the order processing logic may reflect an update of at least one activity instantaneously on the group ordering devices 140A-140C of the group members during the group session.

In several embodiments, prior to or after the dining items are served and consumed by the group members at the table 142, the order processing logic may generate a bill associated with the collaborative order on the digital menu interface and provide one or more customizable payment options associated with the bill on the digital menu interface. The customizable payment options may include, for example, splitting the bill equally or based on individual dining items ordered by each of the group members. The order processing logic may split the bill among the group members based on a selection of one of the customizable payment options. The order processing logic may reflect an update to the bill instantaneously on the group ordering devices 140A-140C of the group members via the digital menu interface based on the split. The order processing logic may, therefore, empower the group members to effortlessly split the total cost of the collaborative order on the bill among themselves, while automatically tracking each group member's share of the bill, and updating individual or group totals in real time or near-real time.

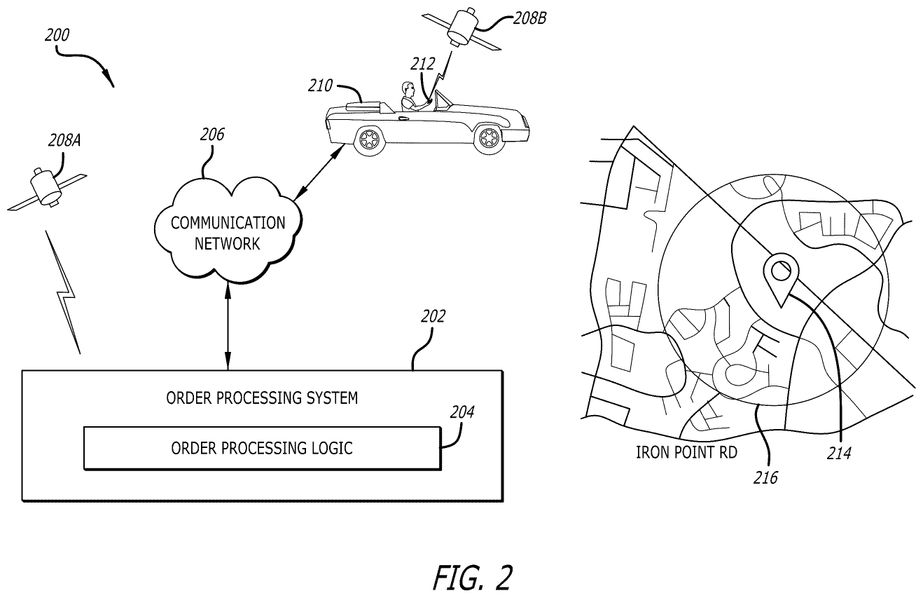

Although a specific embodiment for various environments in which an order processing logic may operate on a plurality of devices for coordinating and processing a collaborative order suitable for carrying out the various steps, processes, methods, and operations described herein is discussed with respect to FIG. 1, any of a variety of systems and/or processes may be utilized in accordance with embodiments of the disclosure. For example, those skilled in the art will recognize that the order processing logic may be provided as a device or a software separate from an order processing system or server or the order processing logic may be integrated into the order processing system. The elements depicted in FIG. 1 may also be interchangeable with other elements of FIGS. 2-17 as required to realize a particularly desired embodiment.

Referring to FIG. 2, an environment 200 including an order processing system 202 for coordinating and processing a collaborative order in accordance with various embodiments of the disclosure is shown. In many embodiments, the order processing system 202 may be accessible to customers of a dining entity, for example, through a broad spectrum of technologies and communication devices such as smartphones, tablet computing devices, endpoint devices, etc., with access to a communication network 206. The customers may include, for example, individual users, group designates, or members of a group, who may order and pay for dining items such as food items, beverage items, or the like, either by dining in at the dining entity, ordering dining items for pickup at the dining entity, or utilizing an online platform for delivery of dining items. The dining entity may, for example, be a restaurant, a café, a food court, a food truck, a canteen, or the like. The communication network 206 may, for example, be a short-range network or a long-range network. Examples of the communication network 206 may include at least one of the Internet, an intranet, a wired network, a wireless network, a communication network that implements Bluetooth® of Bluetooth Sig, Inc., a network that implements Wi-Fi® of Wi-Fi Alliance Corporation, an Ultra-Wide Band (UWB) communication network, a wireless Universal Serial Bus (USB) communication network, a communication network that implements ZigBee® of ZigBee Alliance Corporation, a General Packet Radio Service (GPRS) network, a mobile telecommunication network such as a Global System for Mobile (GSM) communications network, a Code Division Multiple Access (CDMA) network, an Nth generation mobile communication network, where “N” may be 2, 3, 4, 5, 6, etc., a Long-Term Evolution (LTE) mobile communication network, a public telephone network, etc., a local area network, a wide area network, an internet connection network, an infrared communication network, etc., or a network formed from any combination of these networks.

In a number of embodiments, the order processing system 202 may be configured as a server or a network of servers accessible via the communication network 206. In a variety of embodiments, the order processing system 202 may be implemented in a cloud computing environment. The cloud computing environment may refer to a processing environment including configurable, computing, physical, and logical resources, for example, networks, servers, storage media, virtual machines, applications, services, or the like, and data distributed over the communication network 206. The cloud computing environment may, for example, be at least one of a private cloud, a public cloud, or a hybrid cloud. The cloud computing environment may provide on-demand network access to a shared pool of the configurable computing physical and logical resources.

In various embodiments, the order processing system 202 may include an order processing logic 204 configured to define computer program instructions executable by one or more processors of the order processing system 202 for coordinating and processing the collaborative order. The order processing system 202 may store the computer program instructions defined by the order processing logic 204 in a non-transitory, computer-readable storage medium, for example, a memory unit. The non-transitory, computer-readable storage medium may refer to any computer-readable media that contains and stores computer programs and data, except for a transitory, propagating signal. Examples of the computer-readable media may include hard drives, solid state drives, optical discs or magnetic disks, memory chips, a Read-Only Memory (ROM), a register memory, a processor cache, a Random-Access Memory (RAM), etc. In more embodiments, the computer program instructions may implement the processes of various embodiments described herein and perform additional steps that may be required and contemplated for coordinating and processing the collaborative order. The order processing logic 204, when loaded into the non-transitory, computer-readable storage medium and executed by the processor(s), may transform the order processing system 202 into a specially-programmed, special purpose computing system configured to implement the functionality disclosed herein. In additional embodiments, the order processing logic 204 may be a computer-embeddable system that coordinates and processes the collaborative order. In further embodiments, the order processing logic 204 may be implemented as a web-based platform hosted on the order processing system 202. In still more embodiments, the order processing logic 204 may be implemented as an on-premise software installed and run on computers on the premises of the dining entity.

For purposes of illustration, FIG. 2 depicts the order processing logic 204 being run locally on a single order processing system 202; however the scope of the systems, devices, and methods discussed herein may not be limited to the order processing logic 204 being run locally on a single order processing system 202 via an operating system and one or more processors, but may extend to run the order processing logic 204 remotely over the communication network 206 by employing a web browser and a remote server, a mobile phone, or other electronic devices. In still further embodiments, one or more portions of the order processing logic 204 may be distributed across one or more computer systems coupled to the communication network 206. In still additional embodiments, one or more modules, databases, processing elements, memory elements, storage elements, etc., of the order processing system 202 may be distributed across a cluster of multiple computer systems, for example, computers, servers, virtual machines, containers, nodes, etc., coupled to the communication network 206, where the computer systems coherently communicate and coordinate with each other to share resources, distribute workload, and execute different portions of the order processing logic 204 to coordinate and process the collaborative order. Each computer system in the cluster may execute a part of the order processing logic 204, and coordinate with other computer systems in the cluster to provide the complete functionality of the order processing system 202 and the methods discussed herein.

The order processing system 202 may interface with the communication devices, for example, a customer's communication device 212, via the communication network 206, and in some more embodiments, with location-based systems such as GPS systems including GPS satellites 208A and 208B and one or more database systems, to facilitate geofencing and coordinate the collaborative order, and therefore more than one specifically programmed computing system may be utilized for coordinating and processing the collaborative order. The communication device 212 may refer to an electronic device, for example, a smartphone, a tablet computing device, a mobile computer, a portable computing device, a laptop, a wearable computing device such as smart glasses, a smart watch, etc., a client device, a portable electronic device, a network-enabled computing device, an interactive network-enabled communication device, a gaming device, an image capture device, a web browser, a portable media player, any other suitable computing equipment or combinations of multiple pieces of computing equipment.

In yet various embodiments, the order processing system 202 may integrate geofencing technology for group dining scenarios, providing seamless order coordination and pickup arrangements. The dining entity may create a geofenced area 216 of, for example, about a 200-meter radius, around a physical location 214 of the dining entity by utilizing various geofencing tools, and store data associated with the geofenced area 216 in the order processing system 202. In yet more embodiments, the order processing system 202 may provide and host a client application, for example, a mobile application, deployable on the customer's communication device 212 for indicating a presence of the communication device 212 in the geofenced area 216, streamlining browsing of a digital menu rendered on a digital menu interface, and placement of an order. The client application may be configured to run on a single operating system or different operating systems. The order processing logic 204 in the order processing system 202 may monitor the geofenced area 216 around the physical location 214 of the dining entity. For example, the order processing logic 204 may monitor the members of a group, herein referred to as “group members,” who have the client application installed on their communication devices, have provided consent to have the locations of their communication devices tracked, and have enabled location services, via GPS data on their communication devices.

In an example group dining scenario, when a group member drives their vehicle 210 into the geofenced area 216 towards the dining entity to dine in with other group members, the order processing logic 204 may track their entry into the geofenced area 216 around the physical location 214 of the dining entity via their communication device 212 and determine their presence. Similarly, the order processing logic 204 may track the entry of the other group members into the geofenced area 216 via their respective communication devices and determine their presence. In response to the presence of at least two communication devices within the monitored geofenced area 216, the order processing logic 204 may prompt the group members to join a collaborative order via the client application on their communication devices. The order processing logic 204 may establish a group session for the collaborative order based on an acceptance of the prompt on their communication devices. The order processing logic 204 may render a digital menu interface including a digital menu of the dining entity on the client application in each communication device. The group members may perform one or more activities including, for example, selecting one or more dining items offered by the dining entity, modifying the dining item(s), issuing one or more requests, and executing one or more payments via the digital menu interface. The order processing logic 204 may synchronize the activities on the digital menu interface into the collaborative order during the group session in one of real time or near-real time. In still yet more embodiments, the order processing logic 204 may reflect an update of at least one activity instantaneously on the communication devices of the group members during the group session.

In many further embodiments, the order processing logic 204 may render multiple dining items in a catalog format on corresponding dining cards on a menu section of the digital menu interface. In response to a selection of a dining item in the menu section, the order processing logic 204 may expand and execute at least one customization on a dining card associated with the dining item on the digital menu interface, free of navigating away from the menu section. In many additional embodiments, the digital menu interface may include an order screen configured to integrate a set of dining items ordered by the group members during the group session and provide multiple customization options for the collaborative order.

In still yet further embodiments, prior to or after the dining items are served and consumed by the group members, the order processing logic 204 may generate a bill associated with the collaborative order on the digital menu interface. The order processing logic 204 may provide one or more customizable payment options associated with the bill on the digital menu interface. Further, the order processing logic 204 may split the bill among one or more of the group members based on a selection of one of the customizable payment options, and reflect an update to the bill instantaneously on the communication devices of the group members via the digital menu interface based on the split.

In still yet additional embodiments, the order processing logic 204 may transmit at least one promotional element, for example, offers, incentives, or the like, to the communication devices of the group members based on first configurable criteria. The first configurable criteria may include, for example, geolocation data, one or more preferences, or one or more behavioral elements of the group members. In several embodiments, the order processing logic 204 may generate a preference profile of at least one group member, and dynamically generate at least one personalized dining recommendation based on at least one of the preference profile or second configurable criteria. The second configurable criteria may include, for example, a social circle of the group member(s), location data, time, one or more social influencing elements, a reputation, a rating, one or more preferences, one or more behavioral elements, order data associated with the collaborative order, activity data associated with the activities performed on the digital menu interface, one or more reviews, one or more events, or one or more attractions proximal to the dining entity. The terms “first” and “second” are used herein for descriptive purposes only and are not to be construed to indicate or imply relative importance.

In an additional example group scenario, group members may place a collaborative order via the client application on their respective communication devices and designate one group member, herein referred to as a “group designate,” to pick up the order from the dining entity. In several more embodiments, the client application may also provide an option for delivery personnel to pick up the collaborative order from the dining entity and deliver the picked up collaborative order to the group members at a different location. The group designate or the delivery personnel may herein be referred to as “customer.” In numerous embodiments, the order processing logic 204 may execute the placement of the collaborative order for pickup with the dining entity. Further, the order processing logic 204 may monitor the geofenced area 216 around the physical location 214 of the dining entity for a presence of the communication device 212 of the customer. In response to the presence of the communication device 212 associated with the pickup of the collaborative order within the monitored geofenced area 216, the order processing logic 204 may determine an estimated time of the pickup of the collaborative order and prompt the dining entity regarding the estimated time of the pickup of the order.

In numerous additional embodiments, the order processing logic 204 may automatically trigger one or more notifications associated with the pickup of the collaborative order to the communication device 212 based on the estimated time of the pickup. Once the collaborative order is placed and prepared, the order processing logic 204 can automatically trigger notifications to the communication device 212 as the customer enters the geofenced area 216 of the dining entity, prompting the customer, via the communication device 212, to proceed to a designated pickup area. By synchronizing the timing of readiness of the collaborative order with the proximity of the customer's communication device 212 to the dining entity, the order processing system 202 may minimize wait times and ensure that the dining items are served fresh and promptly upon arrival of the customer. By allowing the dining entity to synchronize a timing of a preparation or a completion of the collaborative order with an actual time of arrival of the customer for the pickup of the collaborative order, the dining entity can maintain the intended temperature, texture, or freshness of the dining items by the time the customer arrives, resulting in increased customer satisfaction. Further, the increased visibility into the estimated time of the pickup of the collaborative order may reduce delays in the preparation of the dining items and bottlenecks, particularly during peak hours at the dining entity, thereby optimizing coordination and processing of orders and other areas of restaurant operations, including dine-in and other takeout services.

Although a specific embodiment for an environment 200 including the order processing system 202 for coordinating and processing a collaborative order suitable for carrying out the various steps, processes, methods, and operations described herein is discussed with respect to FIG. 2, any of a variety of systems and/or processes may be utilized in accordance with embodiments of the disclosure. In further additional embodiments, the order processing logic 204 may be a cloud computing-based platform implemented as a service for coordinating and processing the collaborative order. For example, the order processing logic 204 may be configured as a Software as a Service (SaaS) platform or a Cloud-based Software as a Service (CSaaS) platform that coordinates and processes a collaborative order. In many embodiments, the order processing logic 204 may be implemented as a cloud platform service also known as Platform as a Service (PaaS). The elements depicted in FIG. 2 may also be interchangeable with other elements of FIG. 1 and FIGS. 3-17 as required to realize a particularly desired embodiment.

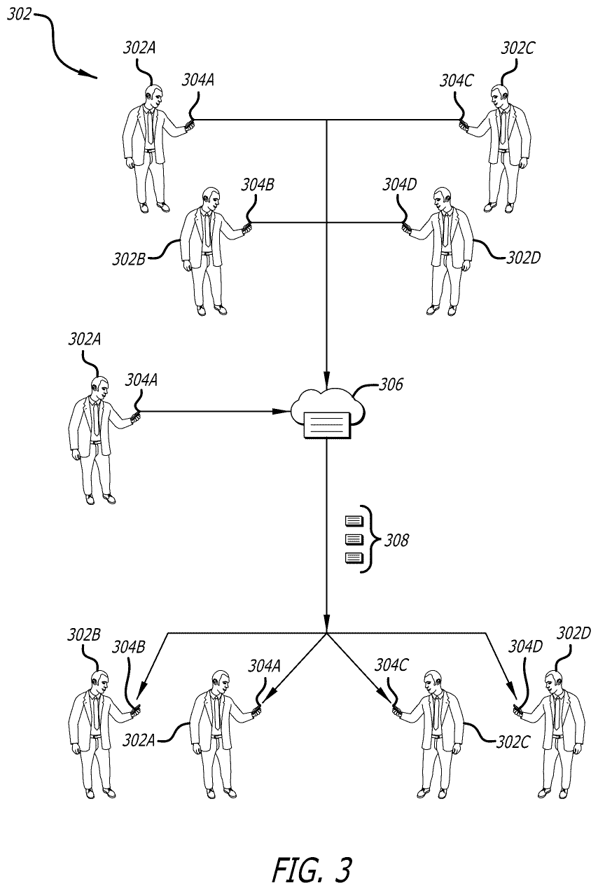

Referring to FIG. 3, a schematic diagram illustrating establishment of a group session and synchronization of activities during the group session in accordance with various embodiments of the disclosure is shown. Group formation and activity synchronization in the context of ordering from a dining entity, for example, a restaurant, may enhance a dining experience, particularly in group dining scenarios, thereby streamlining the process of coordinating orders, preferences, and payments, fostering seamless collaboration and communication among members of a group 302, herein referred to as “group members.” In many embodiments, the systems, devices, and methods discussed herein may leverage pairing of communication devices, for example, smartphones, mobile computers, tablet computing devices, personal digital assistants, or the like, to form a group session between the group members. Consider an example where four group members 302A, 302B, 302C, and 302D collectively referred to as “group members 302A-302D,” pair their respective communication devices 304A, 304B, 304C, and 304D collectively referred to as “communication devices 304A-304D,” to form a group 302 and enter a group session. In a number of embodiments, the group members 302A-302D may pair their respective communication devices 304A-304D via a client application hosted by an order processing system associated with the dining entity to form the group 302. In a variety of embodiments, the order processing system may generate a code, for example, a numeric code, a multi-character code, or an alphanumeric code, for a group session associated with a collaborative order and transmit the code as a prompt to the client application deployed on at least one of the communication devices 304A-304D. The group members 302A-302D may share the code with each other and enter the code into the client application of their respective communication devices 304A-304D to join the group session. The group members 302A-302D may, therefore, pair their communication devices 304A-304D and join the group session by utilizing the code, which may allow the communication devices 304A-304D to link together without sharing personal information of the group members 302A-302D. In various embodiments, the order processing system may transmit the code as a prompt to the client application deployed on each communication device, for example, any of the communication devices 304A-304D, as their presence is detected in a geofenced area created around a physical location of the dining entity.

In more embodiments, the order processing system may establish the group session for the collaborative order based on an acceptance of the prompt on at least two of the communication devices 304A-304D. For example, the order processing system may establish the group session for the collaborative order after validating the code entered by at least two of the group members 302A-302D via their respective communication devices 304A-304D. In additional embodiments, the order processing system may broadcast the group session via a communication network, for example, a Wi-Fi® network, allowing the group members 302A-302D to automatically discover the group session via their respective communication devices 304A-304D. In further embodiments, the group members 302A-302D may pair their respective communication devices 304A-304D by utilizing GPS-based proximity pairing. The order processing system may share location data and allow pairing only if the communication devices 304A-304D are proximal to the physical location of the dining entity, for example, a table at the dining entity, or within a geofenced area around the dining entity.

In still more embodiments, once the group session is established, the order processing system may store data associated with the established group session in a cloud storage system 306 via a communication network. The cloud storage system 306 may refer to a distributed architecture that utilizes a network of remote servers hosted and maintained, for example, by third-party providers, to store the data, ensuring availability, scalability, and durability through data replication and virtualization. The cloud storage system 306 may be configured to operate as a central hub for coordinating and synchronizing all activities and interactions between the group members 302A-302D via the client application installed on their respective communication devices 304A-304D. The client application may display a digital menu interface rendered by the order processing system on each of the paired communication devices 304A-304D. The group members 302A-302D may perform multiple activities, for example, selecting one or more dining items offered by the dining entity, modifying the dining item(s), issuing one or more requests, and executing one or more payments via the digital menu interface displayed on their respective communication devices 304A-304D. Through the cloud storage system 306, the order processing system may synchronize multiple activities performed on the digital menu interface into the collaborative order during the group session. The order processing system can immediately relay any activity initiated by any group member, for example, the group member 302A via their communication device 304A, from browsing a digital menu of the dining entity, selecting dining items, to making special requests, during the group session to the cloud storage system 306. This real-time synchronization of the activities may provide all group members 302A-302D with access to the most up-to-date information and allow the group members 302A-302D to participate in the decision-making process concurrently.

To facilitate rapid communication and data transmission, the cloud storage system 306 may segment the data associated with the group session including, for example, member data, activity data, location data, profile data, or the like into small packets 308, which may then be transmitted to the communication devices 304A-304D of the respective group members 302A-302D. By this method of data transmission, the cloud storage system 306 may minimize latency and deliver updates to the communication devices 304A-304D swiftly, thereby maintaining the integrity of the group session and preventing any delays or discrepancies in the ordering process. Due to this method of data transmission, any activity performed by any of the group members, for example, the group member 302A on their communication device 304A, may be reflected instantaneously on the respective communication devices 304B-304D of the other group members 302B-302D within the group 302. Whether the activity includes, for example, adding a dining item to a cart, modifying an order, or finalizing a payment, the activity data and associated updates may be propagated seamlessly across all the communication devices 304A-304D, creating a synchronized and harmonized ordering experience for the group members 302A-302D.

Through the digital menu interface, the order processing system may eliminate the need for physical menus or cumbersome back-and-forth discussions among the group members 302A-302D, as all relevant data is accessible and shared in real-time through the cloud storage system 306, thereby speeding up the ordering process and reducing the likelihood of errors or miscommunication. Further, the ability to synchronize the activities across multiple communication devices, for example, the communication devices 304B-304D, may foster a sense of inclusivity and collaboration among the group members 302A-302D. The order processing system, in operable communication with the cloud storage system 306, may allow each of the group members 302A-302D to participate in a decision-making process for the collaborative order via the digital menu interface and contribute to shaping the dining experience according to their preferences, thereby promoting satisfaction and democratic engagement among the group members 302A-302D, leading to a more enjoyable and harmonious dining experience overall.

In still additional embodiments, the order processing system may implement anonymous participation of the group members 302A-302D in group dining scenarios by introducing a layer of privacy and convenience for the group members 302A-302D while also facilitating efficient communication between the group members 302A-302D and staff at the dining entity. By utilizing a code, for example, a four-digit code, or other similar methods, each group member, for example, the group member 302A can pair the communication device 304A with the communication devices 304B-304D of other group members 302B-302D in their group 302 without the need to share personal information. The anonymous participation may allow the group members 302A-302D to participate in group ordering or collaboration without concerns about privacy or data security. The use of a code for pairing the communication devices 304A-304D devices may optimize the process of joining the group 302, allowing new group members to seamlessly integrate into existing groups by entering the code. This streamlined approach may reduce friction between the group members 302A-302D, enabling the group members 302A-302D to quickly join the collaborative order or coordinate between themselves without cumbersome registration processes or data sharing requirements. In still further embodiments, the order processing system may extend anonymous participation beyond the group members 302A-302D to include staff at the dining entity, who can join multiple groups by utilizing the code or other similar methods to provide personalized attention and service to the group members 302A-302D. This flexibility allows the staff to efficiently manage orders, address group inquiries or requests, and ensure a positive dining experience for all group members 302A-302D, regardless of the size or complexity of the group 302.

Although a specific embodiment for establishment of a group session and synchronization of activities during the group session suitable for carrying out the various steps, processes, methods, and operations described herein is discussed with respect to FIG. 3, any of a variety of systems and/or processes may be utilized in accordance with embodiments of the disclosure. For example, other than pairing the communication devices 304A-304D via a numeric code, or a multi-character code, or an alphanumeric code to join a group session, the order processing system may generate a Quick-Response (QR) code that may be scanned by the communication devices 304A-304D for joining the group members 302A-302D into the group session. In a further example, the communication devices 304A-304D may detect and pair with each other by utilizing alternative methods such as invite links, Bluetooth® discovery, Wi-Fi® connections, Near Field Communication (NFC), or other wireless, proximity-based communication protocols. The elements depicted in FIG. 3 may also be interchangeable with other elements of FIGS. 1-2 and FIGS. 4-17 as required to realize a particularly desired embodiment.

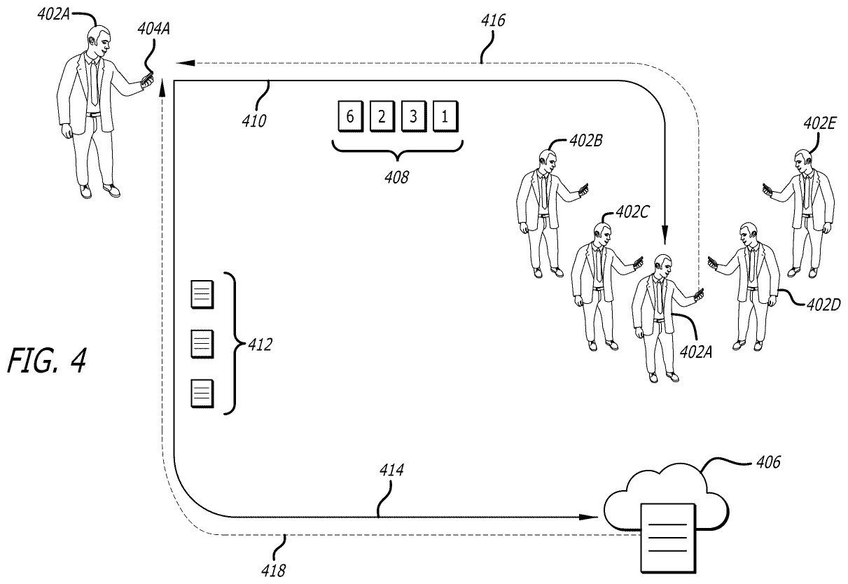

Referring to FIG. 4, a schematic diagram illustrating group fungibility in accordance with various embodiments of the disclosure is shown. Group fungibility may refer to a characteristic of a group 402 in which any of the group members, for example, 402A, 402B, 402C, 402D, and 402E, herein referred to as the “group members 402A-402E,” may join or leave the group 402, without altering a group session and operational effectiveness of the group 402. Group fungibility in the context of ordering from a dining entity, for example, a restaurant, may introduce a dynamic element to a dining experience, allowing the group members 402A-402E to fluidly navigate between different groups and interactions based on their preferences and circumstances. Group fungibility may allow the group members 402A-402E to join or leave the group 402 at any time during the group session, without being tethered to a particular set of group members 402A-402E or commitments. In many embodiments, when the group members 402A-402E join the group session, the order processing system may store activity data associated with their activities on a digital menu interface, in a cloud storage system 406 during the group session. The cloud storage system 406 may refer to a distributed architecture that utilizes a network of remote servers hosted and maintained, for example, by third-party providers, to store the activity data, ensuring availability, scalability, and durability through data replication and virtualization. By implementing group fungibility, the order processing system may perform a seamless transfer of the activity data associated with individual group members 402A-402E to and from the cloud storage system 406.

In a number of embodiments, when a group member, for example, the group member 402A, joins the group 402 and in turn, the group session established by the order processing system, the order processing system may store data associated with the group member 402A as packets 410 in the cloud storage system 406. The group member 402A may join the group 402 and in turn the group session, for example, by entering a numeric code 408 such as “6231”, into a client application hosted by the order processing system on a communication device 404A such as a smartphone of the group member 402A. When the group member 402A chooses to leave the group 402 and in turn the group session, for example, due to a change in plans, dissatisfaction with the group dynamic, or any other reason, the order processing system may delete or remove their activity data including, for example, their preferences, orders, contributions, or the like associated with the group session and their communication device 404A, from the cloud storage system 406. This removal of the activity data of the group member 402A may ensure that the presence of the group member 402A and their influence within the group 402 are accurately reflected, and that the remaining group members 402B-402E can proceed with their activities and interactions without any residual activity data of the departed group member 402A. Further, when the group member 402A chooses to join a new group, the order processing system may seamlessly integrate their activity data with the group session of the new group in the cloud storage system 406, allowing them to pick up where they left off in terms of ordering, preferences, and contributions. This smooth transition ensures continuity and cohesion within the group 402, regardless of changes in group membership or composition.

Group fungibility may, therefore, empower the group members 402A-402E with agency and flexibility, allowing the group members 402A-402E to tailor their dining experiences according to their preferences and social dynamics. For example, whether the group member 402A prefers to dine with a close-knit group of friends, join a larger gathering, or explore new connections, the order processing system, in operable communication with the cloud storage system 406, may allow the group member 402A to navigate between different groups and corresponding group sessions effortlessly. Moreover, group fungibility may streamline the logistics of group dining, particularly in scenarios where plans are subject to change or where the group members 402A-402E may have conflicting commitments. By allowing the group members 402A-402E to join or leave groups and in turn, group sessions, without disruption, the order processing system, in operable communication with the cloud storage system 406, may minimize coordination efforts between the group members 402A-402E and ensure that the ordering process remains smooth and efficient, regardless of fluctuations in group membership. Further, group fungibility may promote inclusivity and diversity within groups by not constraining the group members 402A-402E to rigid social structures or exclusive cliques; instead, based on the seamless data transfer, the group members 402A-402E can interact with a wide range of individuals and contribute to various group dynamics based on their interests and preferences. This inclusivity may foster a sense of belonging and community among the group members 402A-402E, enriching the overall dining experience.

Although a specific embodiment for group fungibility suitable for carrying out the various steps, processes, methods, and operations described herein is discussed with respect to FIG. 4, any of a variety of systems and/or processes may be utilized in accordance with embodiments of the disclosure. For example, in a variety of embodiments, the order processing system, in operable communication with the cloud storage system 406, may allow the group members 402A-402E to join different group sessions simultaneously by synchronizing their activity data across all the group sessions. The elements depicted in FIG. 4 may also be interchangeable with other elements of FIGS. 1-3 and FIGS. 5-17 as required to realize a particularly desired embodiment.

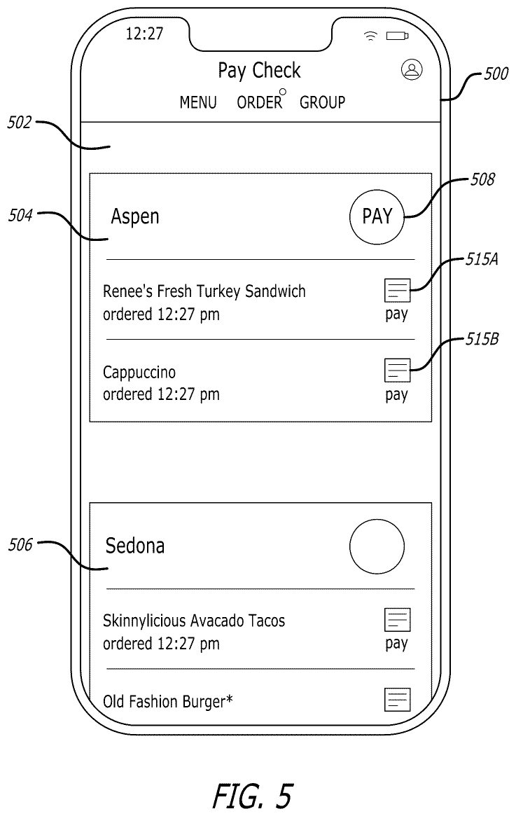

Referring to FIG. 5, a representation of a communication device 500 illustrating a digital menu interface 502 for placement of a collaborative order in accordance with various embodiments of the disclosure is shown. In many embodiments, an order processing system may implement group ordering for enhancing collaboration and coordination among group members. The order processing system may provide an option to the group members to pair their communication devices and form a group, based on which the order processing system may establish a group session, creating a shared space where dining items ordered by each group member via the digital menu interface 502 are aggregated and tracked in real time or near-real time. After forming the group by pairing their communication devices and joining the group session, the group members may proceed to perform multiple activities on the digital menu interface 502 rendered by the order processing system. The order processing system may render the digital menu interface 502 on a client application installed on the communication device 500 of each group member. Via the digital menu interface 502, the group members may perform activities including, for example, browsing a digital menu of a dining entity that is displayed on the digital menu interface 502, selecting one or more dining items from the digital menu, modifying the selected dining item(s), issuing one or more requests, executing one or more payments from the group members, or the like. In a number of embodiments, the digital menu interface 502 may include an order screen configured to integrate a set of dining items, for example, food items, beverage items, or the like, ordered by the group members during the group session and provide a plurality of customization options such as adding, removing, copying, or changing the selected dining items for the collaborative order. As the dining items are added to the group session, the digital menu interface 502 may display the collective selections of the group as illustrated in FIG. 5, facilitating discussions, recommendations, and collaborative decision-making, thereby encouraging engagement and interaction among the group members, enriching a social aspect of the dining experience.

In a variety of embodiments, the order processing system may execute the placement of the collaborative order and generate a bill associated with the collaborative order on the digital menu interface 502. In an example, the digital menu interface 502 may display the dining items ordered by two group members named Aspen and Sedona on respective sections 504 and 506 of the order screen as illustrated in FIG. 5. In various embodiments, the digital menu interface 502 may also provide customizable payment options via interface elements including, for example, buttons or icons for paying the bill associated with the collaborative order. For example, the digital menu interface 502 provide a pay button 508 to allow a group member to pay the total cost of the collaborative order on the bill, and supplementary buttons 510A and 510B to allow the group member to pay costs of individual dining items on the bill.

Moreover, via the digital menu interface 502, the order processing system may allow the group members to view the activities associated with the collaborative order during the group session in real time or near-real time, thereby enhancing transparency and accountability within the group. The order processing system may store activity data associated with the group session in a cloud storage system, which may operate as a central hub for monitoring the activities associated with the collaborative order. This cloud-based group session may allow the group members to monitor the progress of the collaborative order through the digital menu interface 502 and stay informed about what dining items have been selected by their fellow group members. Further, the digital menu interface 502 may allow the group members to easily track which dining items have been ordered, who has contributed to a bill generated by the order processing system, and how the costs of the collaborative order are being distributed among the group members, fostering trust, transparency, and clarity in the payment process among the group members. This transparency may mitigate potential misunderstandings or disputes and promote a harmonious and cooperative dining experience for the group members. The implementation of group ordering may not only enhance the process of coordinating the collaborative order within the group but also foster a sense of camaraderie and shared experience among the group members.

Although a specific embodiment for a communication device 500 illustrating a digital menu interface 502 for placement of a collaborative order suitable for carrying out the various steps, processes, methods, and operations described herein is discussed with respect to FIG. 5, any of a variety of systems and/or processes may be utilized in accordance with embodiments of the disclosure. For example, in more embodiments, the order processing system may host a digital group wallet for the group session, which may contain funds preloaded by one or more of the group members for payment of the bill associated with the collaborative order. The elements depicted in FIG. 5 may also be interchangeable with other elements of FIGS. 1-4 and FIGS. 6-17 as required to realize a particularly desired embodiment.

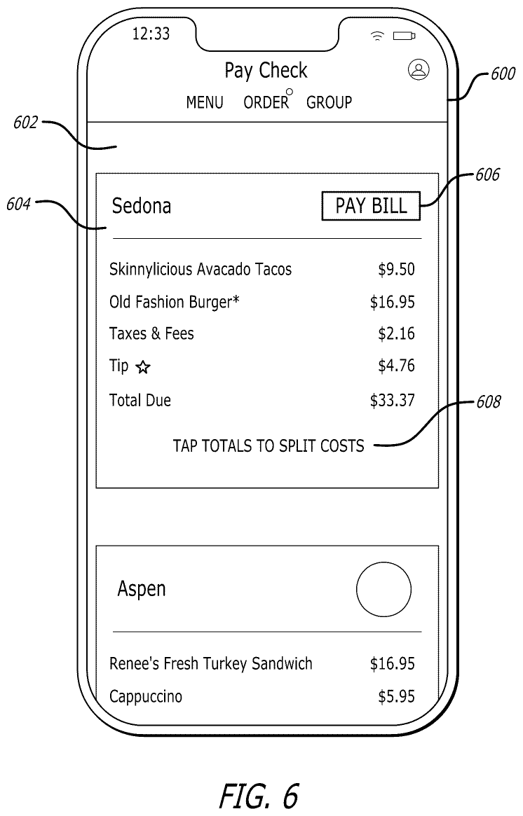

Referring to FIG. 6, a representation of a communication device 600 illustrating a digital menu interface 602 for payment of a collaborative order in accordance with various embodiments of the disclosure is shown. In many embodiments, an order processing system may implement an advanced digital payment system for generating a bill associated with the collaborative order on the digital menu interface 602 and splitting individual costs or a total cost of the collaborative order on the bill among one or more group members. Through the advanced digital payment system, the order processing system may automatically track each group member's share of the total cost and display updated totals instantly on each group member's communication device 600 in real time or near-real time, allowing each group member to pay their updated totals quickly without confusion. This instant visibility into the updated totals may empower the group members to make informed decisions about their contributions and facilitate quick and confident payments, enhancing the overall efficiency and satisfaction of a dining experience. By leveraging the advanced digital payment system, the group members may effortlessly split the total cost on the bill with other group members, either by dividing the cost of individual dining items in the collaborative order or sharing the total cost among multiple group members. The advanced digital payment system may eliminate the difficulty of calculating and exchanging cash or dealing with separate checks or cards, providing a seamless and convenient payment solution for the group members. As dining items are added to the bill or changes are made, through the advanced digital payment system, the order processing system may immediately reflect these changes on each group member's communication device 600, ensuring transparency and accuracy in the payment process. In a number of embodiments, the advanced digital payment system may facilitate payment transactions through electronic means, for example, by utilizing internet protocols, mobile networks, NFC, or the like, and integrate with banking systems, digital wallets, or blockchain platforms to enable seamless, secure payments.

In a variety of embodiments, the advanced digital payment system may provide the ability to split costs seamlessly within the order processing system, enhancing convenience for the group members. Instead of having to manually calculate and divide the bill among multiple group members, the advanced digital payment system may allow each group member to tap totals on the bill rendered on the digital menu interface 602 to split costs directly from their communication devices 600, thereby streamlining the payment process, saving time and effort for the group members. In various embodiments, the advanced digital payment system may implement individual payment within the order processing system to provide a level of granularity and flexibility that caters to diverse preferences and dining habits of group members. In more embodiments, the advanced digital payment system may prompt each group member to pay their own portion of the bill, reflecting the dining items they have individually ordered on respective sections 604 and 606 of the digital menu interface 602 as illustrated in FIG. 6, thereby enhancing the payment process by ensuring fairness and accuracy in splitting costs among the group members.

Consider an example group dining scenario where two group members named Sedona and Aspen place a collaborative order via the digital menu interface 602 rendered by the order processing system. Sedona and Aspen may view the digital menu interface 602 on a client application installed on their respective communication devices 600. Through the advanced digital payment system, the order processing system may generate and render a bill associated with the collaborative order on the digital menu interface 602 as illustrated in FIG. 6. The bill may include respective sections 604 and 606 reflecting the dining items that Sedona and Aspen individually ordered, on the digital menu interface 602. The digital menu interface 602 may render prompts requesting Sedona and Aspen to pay their respective totals. In additional embodiments, the advanced digital payment system may itemize each group member's bill, detailing the specific dining items the group members have ordered, along with taxes, fees, and optional tips. This transparency allows the group members to review their individual charges or totals and make informed decisions about their payments. In further embodiments, the advanced digital payment system may render an interface element, for example, a “pay bill” button 608, on the respective section 604 of the bill displayed on the digital menu interface 602 to allow each group member to pay their individual total. In still further embodiments, the advanced digital payment system may render an option 610 to tap totals to split costs between the group members, on the respective section 604 of the bill displayed on the digital menu interface 602.

By allowing the group members to pay their own totals independently, the advanced digital payment system may accommodate variations in dining preferences and spending habits. For example, one group member may opt for a more elaborate meal with multiple courses, while another group member may prefer a simpler selection. By implementing individual payments, the advanced digital payment system may ensure that each group member is responsible for their own costs on the bill, preventing any discrepancies or disputes over the bill. Individual payment may contribute to a smoother and more efficient dining experience for both group members and staff at a dining entity, for example, a restaurant. By decentralizing the payment process and empowering the group members to settle their own bills, the dining entity can minimize wait times and alleviate congestion at checkout counters, thereby enhancing customer satisfaction and improving operational efficiency of the dining entity. Further, individual payment may foster a sense of autonomy and control for group members, allowing them to manage their own transactions independently. Either by adjusting tip amounts or reviewing detailed breakdowns of their costs, the advanced digital payment system may provide group members with the flexibility to customize their payments according to their preferences, thereby enhancing the overall group experience and reinforcing a positive relationship between the group members and the dining entity.

Although a specific embodiment for a communication device 600 illustrating a digital menu interface 602 for payment of a collaborative order suitable for carrying out the various steps, processes, methods, and operations described herein is discussed with respect to FIG. 6, any of a variety of systems and/or processes may be utilized in accordance with embodiments of the disclosure. For example, the advanced digital payment system may provide customizable payment options including generating payment links to users external to the group for sharing the cost of the collaborative order. The elements depicted in FIG. 6 may also be interchangeable with other elements of FIGS. 1-5 and FIGS. 7-17 as required to realize a particularly desired embodiment.

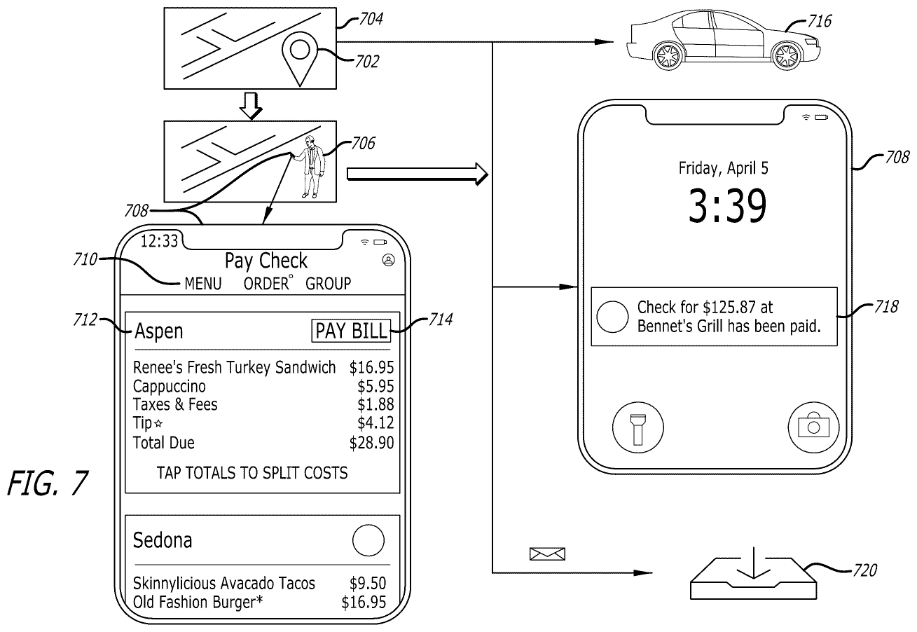

Referring to FIG. 7, a schematic diagram illustrating payment processing for an order in accordance with various embodiments of the disclosure is shown. In many embodiments, an order processing system may implement geofencing-based payment processing for facilitating seamless and secure transactions in the context of dining. The order processing system may facilitate creation of a geofenced area 704 around a physical location 702 of a dining entity, for example, a restaurant. The dining entity may utilize various geofencing tools to mark a geofence around the physical location 702 of the dining entity. The geofence may serve as a virtual perimeter defining a boundary of the dining entity. When a customer 706 enters the geofenced area 704, the order processing system may detect a presence of the customer's 706 communication device 708 and trigger various actions related to the customer's 706 dining experience including, for example, accessing a digital menu of the dining entity on a digital menu interface 710 rendered by the order processing system, placing orders, and making payments. The entry of the customer 706 into the geofenced area 704 may signal to the order processing system that the customer 706 is physically present at the dining entity and likely engaged in dining activities. In response to this signal, the order processing system may trigger generation and activation of an active check, indicating that the customer 706 has initiated a transaction and is in the process of ordering dining items from a digital menu displayed on the digital menu interface 710 that is rendered on a client application installed on the customer's 706 communication device 708.

As the customer 706 progresses through their dining experience, the order processing system may provide an option to review the active check, view the dining items ordered, and settle a bill 712 associated with the active check, on the digital menu interface 710. The digital menu interface 710 may display the bill 712 containing, for example, details of their order including individual dining items, taxes, fees, and suggested tip amounts. This transparency may empower the customer 706 to make informed decisions about their payment and ensure that they have a clear understanding of the total amount due. In a number of embodiments, the customer 706 may leave the geofenced area 704 in their vehicle 716 with the active check.

Once the customer 706 is ready to pay, the customer 706 may initiate the payment process directly from their communication device 708. In a variety of embodiments, the digital menu interface 710 may display an interface element, for example, a “pay bill” button 714, on the bill 712 to allow the customer 706 to pay their total. This seamless integration of payment functionality within the geofenced area 704 may streamline the transaction process, eliminating the need for physical cash or credit cards. The ability to pay the bill 712 with a few taps on their communication device 708 may enhance convenience and efficiency, thereby improving the overall dining experience. Upon completing the payment transaction, the order processing system may transmit a notification 718 to the customer's 706 communication device 708, confirming that their payment has been processed successfully. The notification 718 may provide reassurance to the customer 706 that their payment transaction has been completed and eliminate any uncertainty or ambiguity regarding the status of their payment. In various embodiments, the order processing system may deliver a digital receipt of the payment to the customer's 706 inbox 720, for example, via electronic mail (email), providing a record of the payment transaction for their records and ensuring transparency and accountability.

By implementing geofencing-based payment processing, the order processing system may not only enhance convenience for customers but also offer benefits for dining entities. By automating the payment process and reducing reliance on conventional payment methods, the dining entities can streamline operations, minimize wait times, and improve overall efficiency. Further, the ability to track transactions in real time may provide valuable insights into customer behavior and preferences, enabling the dining entities to optimize their offerings and enhance the dining experience for their customers. Furthermore, geofencing-based payment processing may offer a seamless and secure solution for processing transactions within the geofenced area 704 around the physical location 702 of the dining entity. By leveraging geolocation technology and mobile payment capabilities, geofencing-based payment processing may enhance convenience, efficiency, and transparency for both customers and dining entities, thereby enriching the overall dining experience.

Although a specific embodiment for payment processing for an order suitable for carrying out the various steps, processes, methods, and operations described herein is discussed with respect to FIG. 7, any of a variety of systems and/or processes may be utilized in accordance with embodiments of the disclosure. For example, in more embodiments, the order processing system may facilitate creation of multiple geofenced areas around the physical location of the dining entity for enabling geofencing-based payment processing of a collaborative order at different geofenced areas. The elements depicted in FIG. 7 may also be interchangeable with other elements of FIGS. 1-6, FIGS. 8A-8E, and FIGS. 9-17 as required to realize a particularly desired embodiment.

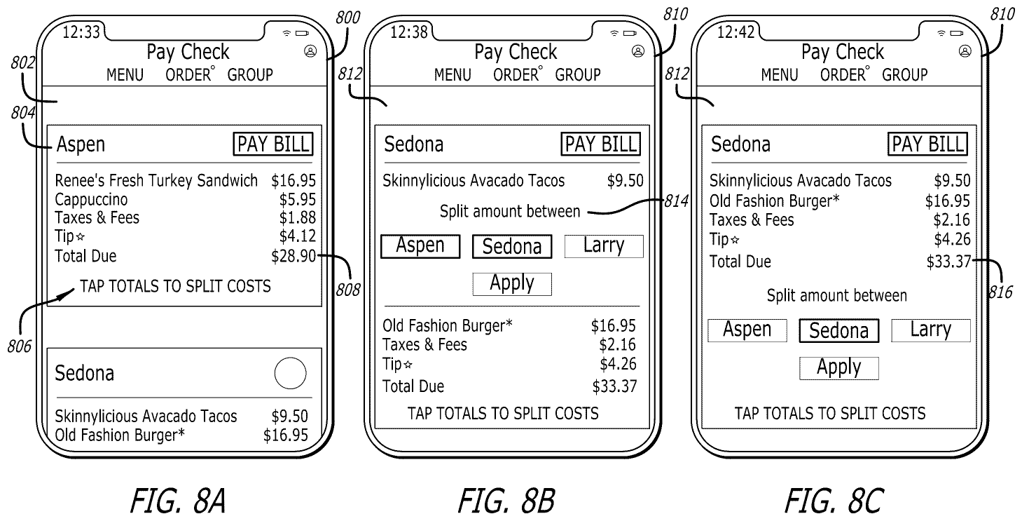

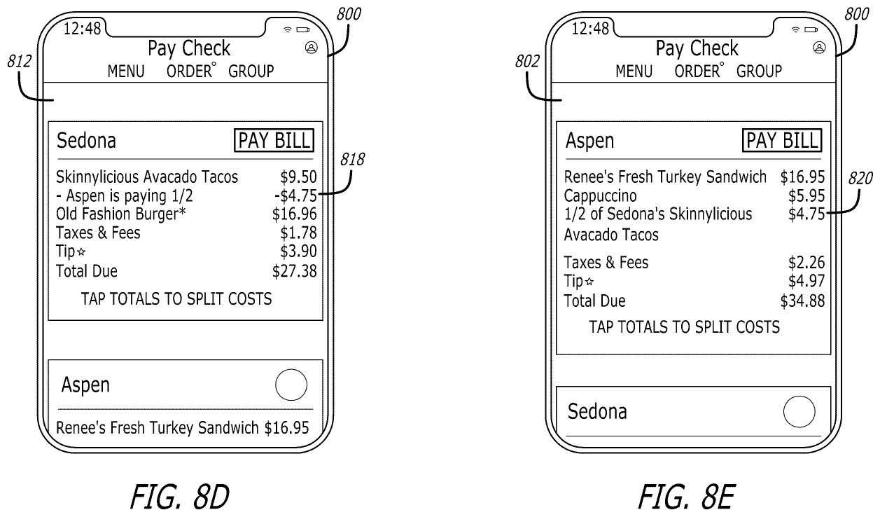

Referring to FIGS. 8A-8E, representations of communication devices 800 and 810 illustrating digital menu interfaces 802 and 812, respectively, for splitting a bill associated with a collaborative order in accordance with various embodiments of the disclosure is shown. Through an advanced digital payment system, an order processing system may generate a bill associated with the collaborative order on a digital menu interface 802 as illustrated in FIG. 8A, and provide one or more customizable payment options associated with the bill on the digital menu interface 802. The customization payment options may include, for example, paying the total cost of the collaborative order, paying for an individual share of the total cost, and/or splitting the total cost or the cost of individual dining items among group members. In many embodiments, the order processing system may split the bill among one or more group members based on a selection of a customizable payment option, and reflect an update to the bill instantaneously on the communication devices 800 and 810 of the group members via their respective digital menu interfaces 802 and 812 based on the split.

Consider an example group dining scenario where two group members named Aspen and Sedona place a collaborative order via the digital menu interfaces 802 and 812 rendered by the order processing system on their respective communication devices 800 and 810. Aspen and Sedona may view the digital menu interfaces 802 and 812 on a client application installed on their respective communication devices 800 and 810 as illustrated in FIGS. 8A-8B. Through the advanced digital payment system, the order processing system may generate and render a bill associated with the collaborative order on the digital menu interface 802 as illustrated in FIG. 8A. The bill may include respective sections 804A and 804B reflecting the dining items that Aspen and Sedona individually ordered, on the digital menu interface 802. The digital menu interface 802 may render prompts requesting Aspen and Sedona to pay their respective totals. In a number of embodiments, the digital menu interface 802 may provide an option 806 to split costs by tapping on any total, for example, a total due 808A or an individual dining item total due 808B displayed on their communication devices 800 and 810. This option 806 may allow the group members to divide the total cost of the collaborative order easily among themselves, for example, cither by splitting the bill evenly between themselves or by allocating specific dining items to different individuals based on their preferences. By tapping on a total, for example, 808A or 808B, on their respective sections 804A and 804B of the bill, the group members can initiate the process of splitting costs, thereby facilitating collaborative payment arrangements within the group. This functionality of splitting costs may be useful in situations where multiple group members have contributed to the collaborative order, ensuring that each group member pays their fair share without the need for manual calculations or negotiations.

Furthermore, tapping on an individual dining item total on their respective sections 804A and 804B of the bill may provide the group members with the flexibility to split specific costs within the collaborative order. For example, if the group members, Aspen and Sedona, share appetizers but order individual entrées, the digital menu interface 802 may allow each group member to choose to split the cost of the shared appetizers while paying for their individual entrées separately. This granular level of control may allow the group members to customize their payment arrangements according to the specifics of their dining experience. FIGS. 8A-8E illustrate various instances where the group members engage in splitting payments for different orders and dining items. For example, Aspen may pay for her turkey sandwich and cappuccino, while Sedona may split the cost of her avocado tacos between herself and Aspen. Further, Sedona may split the cost of her old-fashioned burger between herself and another unnamed person, demonstrating the flexibility to allocate expenses among multiple group members. In the above example scenario, when Sedona clicks on the total 808B displayed for the avocado tacos on her section 804B of the bill as illustrated in FIG. 8A, the advanced digital payment system may render an interface 814 with options to select the group members with whom Sedona would like to split the total 808B for the avocado tacos as illustrated in FIG. 8B. In this example scenario, Sedona may select herself and Aspen with whom she would like to split the total 808 for the avocado tacos by clicking on the names displayed on the interface 814.

The advanced digital payment system may also render an interface 816 to allow Sedona to split the total due 818 in her share of the bill with one or more group members as illustrated in FIG. 8C. In a variety of embodiments, the advanced digital payment system may immediately reflect payment arrangements on the communication devices 800 and 810 of the group members. As the group members initiate splitting of payments, the advanced digital payment system may instantly update and display changes on the respective digital menu interfaces 812 and 802 as illustrated in FIGS. 8D-8E, respectively, providing real-time visibility into the payment status for the group members. For example, the split of the total 808B for the avocado tacos may be reflected as “−$4.75” 820 and 822 in the sections 804B and 804A of the bill displayed on the digital menu interfaces 812 and 802 on the respective communication devices 810 and 800 of Sedona and Aspen as illustrated in FIGS. 8D-8E, respectively. This transparency may ensure that all the group members are aware of their respective contributions and facilitate seamless coordination within the group.

In various embodiments, through the advanced digital payment system, the order processing system may implement remittance of payments directly from a communication device. By allowing customers to pay for their orders directly from their communication devices 800 and 810 without the need to present a physical card or wait in line to pay, dining entities may streamline the payment process and enhance the overall dining experience. The order processing system may store payment transaction details at a payment processor and/or in a cloud storage system. The ability to remit payments directly from their communication devices 800 and 810 may eliminate the need of customers to wait in line or search for staff at a dining entity, for example, a restaurant, to process their payments, thereby allowing the customers to complete payment transactions quickly and conveniently, without shifting focus from enjoying their dining experience at the dining entity. Further, through the advanced digital payment system, the order processing system may update the remittances of payments instantaneously on the communication devices 800 and 810 of the customers. By providing real-time updates to all customers, for example, group members, involved in a collaborative order, the order processing system may foster trust and confidence among the group members, ensuring that all the group members have visibility into the status of payments and contributions. This transparency may also extend to the staff at the dining entity, who are alerted to the remittances and can manage payment transactions without having to handle physical payments or process payment transactions manually. From the perspective of the dining entity, the automation of payment processing may reduce the workload of their staff and streamline operations. By eliminating the need to handle individual payments and process payment transactions manually, staff members can focus on providing attentive service and ensuring a positive dining experience for the customers, thereby allowing dining entities to optimize their staffing levels and resources, leading to improved service and customer satisfaction. By leveraging technology to streamline payment processing and automate transaction management, the dining entities can create a seamless and hassle-free dining experience for customers while improving operational efficiency and reducing the workload for their staff.

Although a specific embodiment for communication devices 800 and 810 illustrating digital menu interfaces 802 and 812 for splitting a bill associated with a collaborative order suitable for carrying out the various steps, processes, methods, and operations described herein is discussed with respect to FIGS. 8A-8E, any of a variety of systems and/or processes may be utilized in accordance with embodiments of the disclosure. For example, the order processing system may store payment transaction details at a payment processor operating at an external digital payment system and/or in a cloud storage system. The elements depicted in FIGS. 8A-8E may also be interchangeable with other elements of FIGS. 1-7 and FIGS. 9-17 as required to realize a particularly desired embodiment.

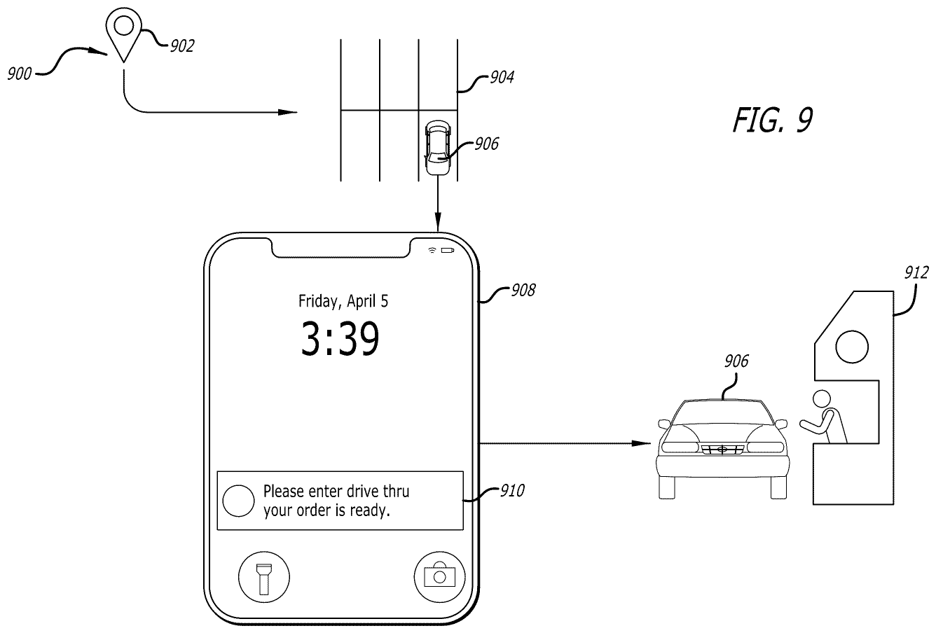

Referring to FIG. 9, a schematic diagram illustrating synchronization of a completion of an order with an estimated time of a pickup of the order in accordance with various embodiments of the disclosure is shown. In many embodiments, an order processing system may execute a placement of an order by proximity zone for streamlining the process of ordering dining items, for example, food items, beverage items, or the like, for pickup at a dining entity such as a restaurant 902. By leveraging geolocation technology and proximity detection, the order processing system may ensure that orders are prepared and ready for pickup precisely when needed.

Consider an example scenario where a customer such as an individual or a group places an order for pickup at a restaurant 902. The individual or the group may place the order for pickup by utilizing a client application deployed on each of their communication devices. The client application may be associated with the restaurant 902. Upon confirmation of the order by the restaurant 902, the group may assign a designated member, herein referred to as a “group designate,” to pick up the order on behalf of the group. This designation may streamline the pickup process, ensuring that only one person needs to physically visit the restaurant 902 while still allowing the entire group to enjoy their meal together. The order processing system may monitor a proximity zone or a geofenced area around the restaurant 902 to detect a presence of a communication device 908 of the group designate. The entry of the group designate into the proximity zone or the geofenced area around the restaurant 902 may trigger the order processing system and signal staff at the restaurant 902 that the pickup is imminent. In a number of embodiments, the real-time proximity detection may serve as a cue for the restaurant 902 to initiate preparation of the ordered dining items, optimizing efficiency by synchronizing the order preparation process including preparation of the ordered dining items with the arrival of the group designate. By initiating the order preparation based on the proximity of the group designate, the order processing system may minimize wait times and ensure that orders are fresh and ready for pickup upon arrival.

The implementation of the order processing by proximity zone not only enhances operational efficiency for the restaurant 902 but also improves the overall customer experience. Customers no longer need to wait in line or contend with long wait times upon arrival at the restaurant 902. The seamless coordination between the order placement and pickup by the order processing system may ensure a smooth and hassle-free experience, allowing the customers to enjoy their meal without unnecessary delays. From a logistical standpoint, order processing by proximity zone may also offer benefits in terms of resource allocation and time management for both customers and staff at the restaurant 902. By accurately predicting the arrival time of the group designate based on their proximity to the restaurant 902, the order processing system may allow the staff to optimize their workflow and allocate resources more effectively, thereby ensuring that the ordered dining items are prepared in a timely manner and that staff members are available to assist with the pickup process as needed. Moreover, order processing by proximity zone may assist customers, particularly in scenarios where timing is crucial, for example, during busy lunch hours or when coordinating the pickup with other activities. By leveraging real-time proximity detection, customers can schedule their time of pickup with precision, minimizing wait times and maximizing convenience.

Consider another example scenario of processing an order based on an estimated time of a pickup of the order at a restaurant 902. Estimating the timing of the pickup of the order may provide a streamlined and efficient approach to a dining experience, for example, for those customers opting for a drive-through or drive-thru service. The drive-thru service at the restaurant 902 may refer to a service where a customer may pick up their order without leaving the customer's vehicle 906. In this example scenario, the order processing system may transmit notifications to the customer's communication device 908 instructing the customer to wait in a nearby parking lot 904, upon arrival at the restaurant 902, thereby allowing for smoother traffic flow at the restaurant 902 and ensuring that the customer has a designated waiting area where the customer can prepare for the pickup process. During the waiting period, the order processing system may provide the customer with an option to pay for their order directly on their communication device 908, thereby leveraging the convenience of mobile payment technology, allowing the customer to settle their bill seamlessly without the need for physical cash or card transactions.

By enabling payment while waiting, the order processing system can expedite the pickup process and minimize delays when the customer reaches a pickup area 912 of the restaurant 902. When the order is ready for the pickup, the order processing system may transmit a notification 910 to the communication device 908 to enter the pickup area 912 for picking up the order. Upon receiving the notification 910, the order processing system may prompt the customer via the communication device to proceed to designated drive-thru lanes to reach the pickup area 912, where their order is ready for pickup. Through the notification 910, the proactive communication provided by the order processing system may ensure that the customer is informed and prepared to pick up their order efficiently, minimizing wait times and congestion at the pickup area 912. The seamless coordination between the customer, staff at the restaurant 902, and the order processing system may allow a rapid and smooth drive-thru pickup process, with vehicles, for example, the vehicle 906, moving swiftly through the drive-thru lanes. By optimizing the flow of orders and streamlining operations, the restaurant 902 can fulfill the orders promptly and ensure that the customers receive their orders while the dining items in the orders are still fresh and at the right temperature.

Although a specific embodiment for synchronization of a completion of an order with an estimated time of a pickup of the order suitable for carrying out the various steps, processes, methods, and operations described herein is discussed with respect to FIG. 9, any of a variety of systems and/or processes may be utilized in accordance with embodiments of the disclosure. For example, various types of Artificial Intelligence (AI) models may be utilized for estimating the timing of the pickup of the order. The elements depicted in FIG. 9 may also be interchangeable with other elements of FIGS. 1-7, FIGS. 8A-8E, and FIGS. 10-17 as required to realize a particularly desired embodiment.

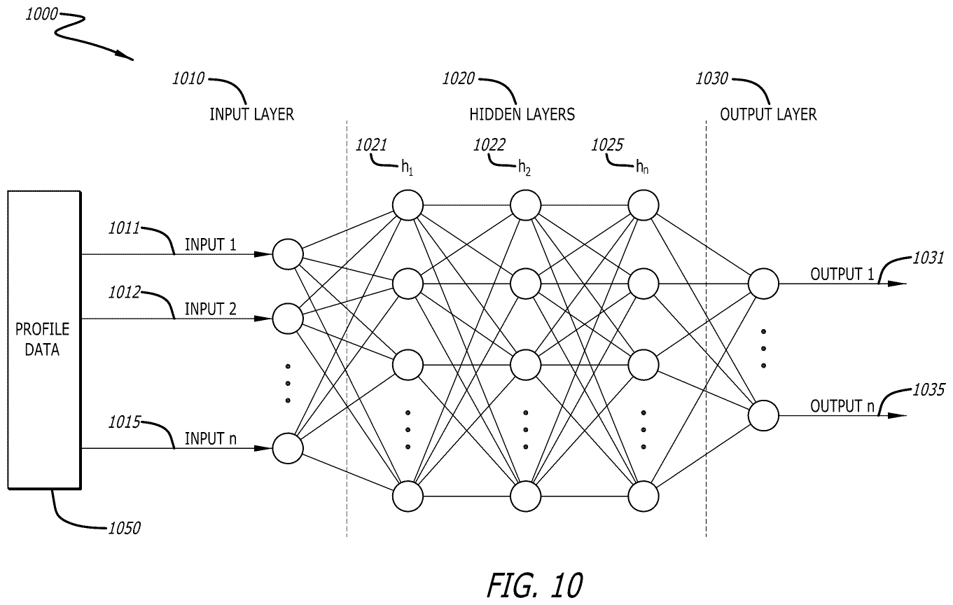

Referring to FIG. 10, a schematic diagram illustrating an example neural network 1000 in accordance with various embodiments of the disclosure is shown. As those skilled in the art will recognize, neural networks can be utilized in one or more machine learning processes. The embodiment illustrated in FIG. 10 specifically depicts a feedforward neural network with multiple layers. This type of neural network includes an input layer 1010, one or more hidden layers 1020, and an output layer 1030. Each layer contains nodes or neurons that are interconnected, representing how data flows through the feedforward neural network. The input layer 1010 can receive raw profile data 1050 of customers of a dining entity, which is then processed by the hidden layers 1020 through weighted connections and activation functions. The profile data 1050 may include, for example, customer or group member data, location data, preferences, behavioral elements, order data, activity data associated with one or more activities performed on a digital menu interface, or the like. These hidden layers 1020 can enable the feedforward neural network to learn complex patterns and relationships within the profile data 1050. The final output layer 1030 produces predictions or classifications of the feedforward neural network based on the processed profile data. The interconnected nature of the nodes allows the neural network 1000 to learn from the profile data 1050 during training by adjusting weights of connections to minimize prediction errors. This structure is the foundation of deep learning models, as adding more hidden layers 1020 can create a deep neural network, capable of tackling highly complex tasks such as image recognition, Natural Language Processing (NLP), and pattern detection in large datasets.

A perceptron or a single artificial neuron is the building block of Artificial Neural Networks (ANNs) and can perform forward propagation of information. For a set of inputs to the perceptron, weights and biases to shift the weights can be assigned. These inputs and weights can be multiplied out correspondingly together to obtain a sum output. Those skilled in the art may recognize tools such as, but not limited to, PyTorch, Tensorflow, and MXNet as training packages for common neural network tasks. However, it is contemplated that other tools may be developed specifically for the neural network tasks related to the embodiments described herein.

In many embodiments, weight matrices of the neural network 1000 can be initialized randomly or obtained from a pre-trained model. These weight matrices can be multiplied with the input matrix or output from a previous layer and subjected to a nonlinear activation function to yield updated representations, which are often referred to as activations or feature maps. A loss function, also referred to as an objective function or an empirical risk, can often be calculated by comparing the output of the neural network 1000 and known target value data.

Feedforward neural networks, such as the neural network 1000 depicted in the embodiment of FIG. 10, are often configured as neural networks where information moves in one direction, from the input layer 1010 through the hidden layers 1020 to the output layer 1030, without any cycles or loops. The feedforward neural networks are primarily utilized for tasks such as classification, regression, and simple pattern recognition, where each input is processed independently of others. In contrast, backpropagation is not a separate type of network but rather a training algorithm commonly utilized in both feedforward and other types of neural networks such as Recurrent Neural Networks (RNNs).

Backpropagation involves adjusting the weights of the neural network in a reverse direction, for example, from output to input, based on an error between a predicted output and an actual target during training. While feedforward describes the structure and data flow within the neural network, backpropagation is a technique utilized to optimize the model. Feedforward neural networks are utilized for straightforward tasks where input-output relationships are not sequential or time-dependent. However, for problems involving learning complex patterns over time, such as speech recognition or time-series analysis, neural networks such as RNNs or deep feedforward networks with many hidden layers, that employ backpropagation for training, may be utilized to capture these intricate dependencies.

Typically, in these network arrangements, the weights are iteratively updated via various methods including, but not limited to, stochastic gradient descent algorithms to help minimize the loss function until a desired accuracy is achieved. Most modern deep learning frameworks can facilitate this iterative update by using reverse-mode automatic differentiation to obtain partial derivatives of the loss function with respect to each network parameter through recursive application of a chain rule. Colloquially, this is also known as backpropagation. Common gradient descent algorithms can include, but are not limited to, Stochastic Gradient Descent (SGD), Adam, Adagrad, etc. Learning rate is one of the parameters in gradient descent. Except for SGD, all other methods utilize adaptive learning parameter tuning. Depending on the objective such as classification or regression, different loss functions such as Binary Cross Entropy (BCE), Negative Log Likelihood Loss (NLLL), or Mean Squared Error (MSE) can be utilized.

Neural network architecture is commonly utilized for a wide range of tasks in fields such as computer vision, NLP, financial forecasting, and materials science. For instance, the neural network architecture can be employed to recognize patterns in images such as identifying objects or faces, or to classify text of the profile data 1050 into categories such as demographic data, location data, behavioral data, preferences, or the like. The neural network architecture is also useful in regression problems, such as predicting an arrival time of a customer for pickup of an order or predicting dining entities that the customer may prefer, or predicting pairings between dining items such as beverage pairings with food items, where input features can be processed to output continuous values. However, this is a general example of an AI model, illustrating how a feedforward neural network works. Depending on the problem, other methods and models may be more appropriate. For example, Convolutional Neural Networks (CNNs) are often utilized for image processing tasks, while RNNs are suitable for sequential data such as time series data or text. Additionally, simpler models such as linear regression, decision trees, or Support Vector Machines (SVMs) may be sufficient if the problem is less complex, or a dataset is relatively small. The embodiment depicted in FIG. 10 is presented as an example Machine Learning (ML) solution that may be deployed within one or more methods or systems described herein.

In a number of embodiments, the input layer 1010 is the first layer in the neural network 1000 and serves as the initial point where raw profile data 1050 is introduced into the model. Each node or neuron in this input layer 1010 represents an individual feature or variable from the dataset, allowing the neural network 1000 to receive and process various types of data, such as features in the profile data 1050, pixel values in an image, numerical features in a spreadsheet, or words in a text document. For instance, in image recognition tasks, the input layer 1010 can include nodes that correspond to pixel values of the image, providing the neural network 1000 with visual information needed to identify objects or patterns. The number of nodes in the input layer 1010 directly depends on the number of features present in the dataset. If there are one hundred features in the profile data 1050, the input layer 1010 may typically have one hundred nodes, each conveying one piece of the information to the subsequent layers. In a variety of embodiments, the inputs of the neural network 1000 are generally scaled, that is, normalized to have a zero mean and/or a unit standard deviation. Scaling can also be applied to the input of the hidden layers 1020, for example, by utilizing batch or layer normalization to improve the stability of the neural network 1000.

Unlike the hidden layers 1020 and the output layer 1030, the input layer 1010 typically does not perform any computations or transformations on the data. The primary function of the input layer 1010 is often to pass the input data to the next layer in the neural network 1000, that is, the first hidden layer 1021. However, it is often desired that the data fed into this first hidden layer 1021 is preprocessed appropriately, such as being normalized or standardized, to ensure that the neural network 1000 can learn efficiently. Proper preprocessing, for example, scaling numerical values or encoding categorical variables, can help the neural network 1000 process data uniformly, facilitating more stable and faster convergence during training.

The design of the input layer 1010 depends on the nature of the problem. For example, in NLP, the input layer 1010 may represent words encoded as numerical vectors, while in time series analysis, each node may represent a data point in a sequence. While the input layer 1010 itself does not modify the data, the input layer 1010 sets the stage for the neural network 1000 to extract complex patterns and relationships through the deeper layers. This flexibility in handling various types of input make the neural network 1000 a powerful tool for a diverse set of applications.

With respect to the embodiments described herein, the input layer 1010 may be configured with a plurality of inputs providing profile data 1050. For example, the ML model can be configured with a first input 1011 configured as order data, a second input 1012 configured as activity data, while additional inputs can be added related to location data and other behavioral data of the customer. The nth input 1015 can be configured in various embodiments to include audio data. However, as those skilled in the art will recognize, additional setups can be configured such that the inputs 1011, 1012, and 1015 can be configured to also include different parameters such as preferences, social influencing elements, reviews, etc.

In more embodiments, the neural network 1000 comprises a plurality of hidden layers 1020. The embodiment depicted in FIG. 10 comprises a first hidden layer 1021, a second hidden layer 1022, and an nth hidden layer 1025, which are denoted as h₁, h₂, and hₙ, respectively. In additional embodiments, the hidden layers 1020 are disposed where the core of the ML model's learning and pattern recognition occurs. In each of the hidden layers 1020, individual neurons receive inputs from the previous layer, apply a set of weights, add a bias, and pass the result through an activation function, for example, Rectified Linear Unit (ReLU), leaky ReLU, sigmoid, hyperbolic tangent (tanh), Swish, etc. This process can introduce non-linearity, allowing the neural network 1000 to capture complex patterns in the data that simple linear models cannot. The intricate web of connections among neurons across layers helps the neural network 1000 transform and process input features into representations that become progressively more abstract and useful for making predictions.

The first hidden layer 1021, h₁, receives direct input from the input layer 1010, transforming the raw profile data 1050 into an initial set of features. For example, in an order processing system, the first hidden layer 1021 may initiate differentiating between types of data such as textual data including order data, activity data, location data, etc., audio data, video data, interaction data including chat, reactions, audio participation, etc. The output of the first hidden layer 1021 is then passed to the second hidden layer 1022, h₂, which builds upon the features identified by the first hidden layer 1021. This deeper second hidden layer 1022 may start recognizing more complex patterns, for example, identifying time ranges when regular orders are placed, delays on certain days in certain locations, locations where high-value orders are placed, cancelation of orders in certain geofenced areas, repeat orders, repeat dining items, or the like, by combining the lower-level features identified in the previous hidden layer. This can continue until a last, nth hidden layer 1025, hₙ, continues this abstraction process, allowing the neural network 1000 to recognize even higher-level, more detailed features, such as identifying group preferences, consistent weekday group ordering patterns tied to specific zones and times, or the like, or understanding intricate relationships in the input profile data 1050. With respect to the embodiments described herein, the hidden layers 1020 may learn one or more patterns of the input profile data 1050 to extract higher-level features from the raw profile data 1050, thereby improving the ability of the ML model to perform coordination and processing of collaborative orders.

Each of the hidden layers 1020 adds a level of complexity and abstraction to the learning capabilities of the neural network 1000. The multi-layer structure can enable the neural network 1000 to move from recognizing simple patterns in the first hidden layer 1021 to highly complex, abstract concepts in the deeper hidden layers. The number of hidden layers 1020 and neurons within them can vary depending on the complexity of the problem. More hidden layers 1020 generally allow the neural network 1000 to model more intricate functions, making deep neural networks especially effective for tasks such as image recognition, NLP, order assistance, and complex predictive modeling. However, adding more layers also increases the computational demand and the risk of overfitting, highlighting the need to carefully design and tune these hidden layers 1020 for optimal performance.

In further embodiments, the output layer 1030 is often the final layer in the neural network 1000 and is responsible for producing predictions or classifications of the profile data 1050, for example, for providing order assistance or generating personalized dining recommendations based on the information processed through the previous hidden layers 1020. Each neuron in the output layer 1030 can represent a specific outcome or category that the ML model can predict. In the embodiment depicted in FIG. 10, the outputs are labeled as “output 1” 1031 to “output n” 1035, indicating that the neural network 1000 can be designed to have a varying number of outputs depending on the nature of the problem being solved. For example, in a binary classification such as joining or leaving a group session for a collaborative order, there would typically be a single output neuron that provides a probability score for one of the two classes/outcomes. In contrast, for multi-class classification, for example, categorizing the profile data 1050 into different types such as order data, activity data, preference data, behavioral data, or the like, the output layer 1030 would contain multiple neurons, each corresponding to a different class.

The number of neurons in the output layer 1030 can also be designed specifically for other types of tasks, such as regression, where the ML model can predict continuous values. In such cases, the output layer 1030 may contain a single neuron representing a numerical prediction, such as an estimated time of a pickup of an order or an estimated time until completion of the order. Alternatively, in complex applications such as multi-label classification, where each input can belong to multiple classes simultaneously, the output layer 1030 could have multiple neurons, each representing a different class, with each neuron outputting a probability of the input belonging to that specific class.

The activation function utilized in the output layer 1030 can vary based on the desired output. For binary classification, a sigmoid function is commonly utilized to produce a probability between 0 and 1. For multi-class classifications, a softmax function can be applied to output a set of probabilities that sum to 1, indicating the most likely class. For regression problems, a linear activation function is often utilized to output a continuous range of values. The flexibility in designing the output layer 1030 allows the neural network 1000 to be applied to a wide variety of tasks, from simple binary decisions to complex multi-output predictions, making them a versatile tool in artificial intelligence and machine learning.

Although a specific embodiment for an example neural network 1000 suitable for carrying out the various steps, processes, methods, and operations described herein is discussed with respect to FIG. 10, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 10, which is an illustrative example that explains the basic concepts of neural networks and how they process information. The specific features and functions described herein are not intended to be limiting to this specific embodiment. The elements depicted in FIG. 10 may also be interchangeable with other elements of FIGS. 1-9 and FIGS. 11-17 as required to realize a particularly desired embodiment.

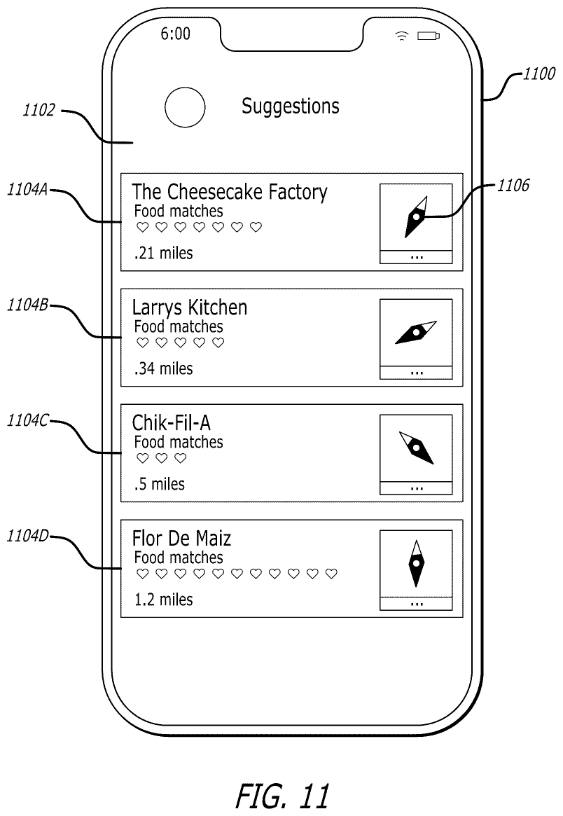

Referring to FIG. 11, a representation of a communication device 1100 illustrating a graphical user interface 1102 displaying a list of personalized recommendations of dining entities with compass elements 1106 pointing to physical locations of the dining entities in accordance with various embodiments of the disclosure is shown. In many embodiments, a personalized recommendation system may be configured to leverage customer-generated data and advanced algorithms to generate and render dynamic and personalized dining suggestions or recommendations tailored to individual preferences.

A customer may, for example, be an individual user, a diner, a member of a group formed for placing a collaborative order, a group designate, or the like. In a number of embodiments, the personalized recommendation system may generate a preference profile of the customer and dynamically generate at least one personalized recommendation based on at least one of the preference profile or configurable criteria. The configurable criteria may include, for example, at least one of: a social circle of the customer, location data, time, one or more social influencing elements, a reputation, a rating, one or more preferences, one or more behavioral elements, order data associated with orders placed by the customer, activity data associated with activities performed by the customer during a group session for placement of a collaborative order on a digital menu interface, one or more reviews, one or more events, or one or more attractions proximal to dining entities, for example, restaurants. In a variety of embodiments, the personalized recommendation system may capture and analyze choices of dining items, for example, food items, beverage items, or the like, and feedback from customers to generate detailed preference profiles of their dining preferences. By discerning patterns and preferences, the personalized recommendation system may deliver tailored dining recommendations associated with the dining entities and the dining items.

In various embodiments, the personalized recommendation system may implement geofencing to transmit personalized recommendations of the dining entities, also referred to as “personalized dining recommendations,” to a customer's communication device when the communication device enters a geofenced area created around any physical location. The personalized recommendation system may determine a presence of the customer's communication device when the communication device enters the created geofenced area and transmit the personalized dining recommendations to the customer's communication device. For example, as the customer traverses a specific geofenced area, the personalized recommendation system may generate tailored suggestions for nearby dining entities in the form of personalized dining recommendations and transmit the personalized dining recommendations to the customer's communication device based on their preferences, geo-location data, or a combination thereof. These personalized dining recommendations may not be merely generic listings of nearby dining entities, but may be finely tuned to match the customer's tastes and preferences. The implementation of geofencing technology may ensure that the personalized dining recommendations are not only relevant but also timely, considering the customer's current position and surrounding dining options.

In more embodiments, the personalized recommendation system may include dining items, for example, food items, beverage items, or the like, that match the customer's preferences in the generation of the personalized dining recommendations. Inclusion of the dining items in the generation of the personalized dining recommendations may highlight the ability of the personalized recommendation system to align options of dining entities with the customer's preferred cuisine or dietary restrictions. This personalization adds a layer of convenience and relevance, ensuring that the customer is presented with choices that resonate with their palate. Moreover, the inclusion of highly curated dining entities may imply a level of quality assurance, suggesting that the personalized dining recommendations are based on factors beyond just proximity, such as reputation, ratings, and reviews.

In additional embodiments, the personalized recommendation system may render a list of the personalized recommendations of dining entities on separate sections 1104A, 1104B, 1104C, and 1104D on the graphical user interface 1102 of the customer's communication device 1100 as illustrated in FIG. 11. In addition to names of the dining entities, the sections 1104A, 1104B, 1104C, and 1104D may also display distances of the dining entities with respect to the customer's communication device 1100. In further embodiments, the personalized recommendation system may also render a compass element 1106 pointing to a line of sight associated with a physical location of each recommended dining entity, on the graphical user interface 1102 of the communication device 1100. The compass elements 1106 displayed in the sections 1104A, 1104B, 1104C, and 1104D on the graphical user interface 1102 may provide visual aids that not only help the customer orient himself or herself relative to the recommended dining entities but also enhance the overall customer experience by providing clear and intuitive navigation guidance. By integrating spatial awareness into the recommendation process, the personalized recommendation system may bridge a gap between digital information and real-world exploration, facilitating seamless decision-making and navigation for the customer.

In still more embodiments, the personalized recommendation system may underscore the power of data analytics and machine learning in delivering hyper-personalized experiences. By analyzing customer behavior, preferences, and contextual data such as location and time within a geofenced area, the personalized recommendation system can anticipate and cater to the customer's needs in real time or near-real time. This level of customization may not only enhance customer satisfaction but also foster loyalty and engagement with the personalized recommendation system.

In still further embodiments, an order processing system associated with a dining entity may implement a loyalty and rewards program for fostering customer engagement and incentivizing repeat business. In still additional embodiments, the order processing system may leverage payments remitted by customers to track the amount spent and visits made by the customers, forming the foundation of the loyalty and rewards program. The loyalty and rewards program may allow the dining entities to not only track customer spending habits but also to reward loyal customers for their continued support and patronage. Based on tracking the remitted payments, the loyalty and rewards program established by the order processing system may offer various benefits and incentives to customers based on their spending behavior. For example, the customers may accumulate points or credits with each order placed at a dining entity, which can be redeemed for discounts, free items, or other rewards on future visits to the dining entity, thereby incentivizing the customers to return to the dining entity and providing the customers with tangible benefits for their loyalty and support. In some more embodiments, as the customers make payments for their orders, the order processing system may track the amount spent and associate the amount spent with the customer's preference profile. Over time, the customers accrue benefits, for example, discounts or cash equivalents, which can be redeemed during subsequent visits to the dining entity, thereby creating a positive feedback loop where the customers are rewarded for their loyalty, leading to increased satisfaction and retention.

In yet various embodiments, the loyalty and rewards program may contribute to building stronger relationships between the dining entities and their customers. By offering personalized incentives and rewards, the dining entities can demonstrate appreciation for their customers' patronage and encourage ongoing engagement, thereby fostering a sense of loyalty and brand affinity among the customers, increasing the likelihood of repeat visits and word-of-mouth referrals. In yet more embodiments, the loyalty and rewards program may provide the dining entities with valuable insights into customer behavior and preferences. By analyzing data collected through the loyalty and rewards program, the dining entities can gain a deeper understanding of their customer base, allowing them to tailor offerings, promotions, and marketing campaigns to better meet the needs and preferences of their customers.

Although a specific embodiment for a communication device 1100 illustrating a graphical user interface 1102 displaying a list of personalized recommendations of dining entities with compass elements 1106 pointing to physical locations of the dining entities suitable for carrying out the various steps, processes, methods, and operations described herein is discussed with respect to FIG. 11, any of a variety of systems and/or processes may be utilized in accordance with embodiments of the disclosure. For example, in still yet more embodiments, the personalized recommendation system may utilize various AI models, for example, NLP models, knowledge graphs, deep learning models, or the like to generate personalized dining recommendations of pairings between the dining items, for example, beverage pairings with food items, thereby adding a supplementary layer of personalization and enhancing the overall dining experience. The elements depicted in FIG. 11 may also be interchangeable with other elements of FIGS. 1-10 and FIGS. 12-17 as required to realize a particularly desired embodiment.

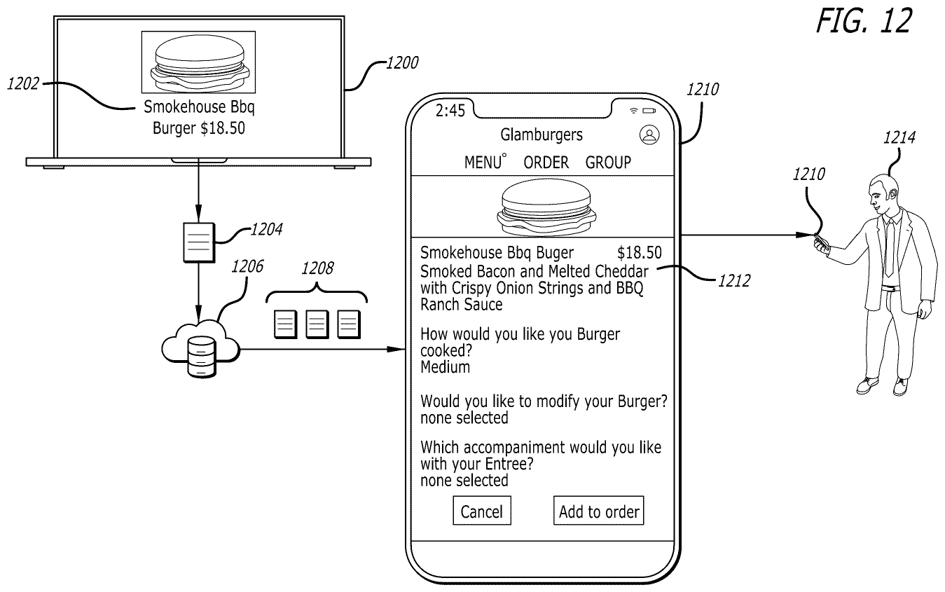

Referring to FIG. 12, a schematic diagram illustrating an instantaneous update of content 1202 of a menu on a digital menu interface 1212 in accordance with various embodiments of the disclosure is shown. In many embodiments, an order processing system may implement a menu management system that employs a data sharing method for managing and presenting the content 1202 of the menu to customers of a dining entity, for example, a restaurant. As conventional menu management systems often encounter latency issues, where updates made to the content of the menu take time to reflect on a customer's digital menu interface, potentially leading to discrepancies and a subpar customer experience, the embodiments described herein may implement real-time data sharing to immediately mirror any updates made to the menu's content 1202 on a client application deployed on a customer's 1214 communication device 1210. The client application may, for example, be a mobile application installed on the customer's 1214 communication device 1210 such as a smartphone. In a number of embodiments, the client application may be provided and hosted by the order processing system of the dining entity.

By providing a real-time content preview, the menu management system may allow restaurant operators, content creators, content authors, or the like, herein referred to as “users,” to update their menus, for example, by adding or modifying dining items, before publishing them to a wider audience. This functionality may empower the users to iterate quickly and efficiently, ensuring that the digital menu interface 1212 immediately reflects the latest offerings, pricing, and descriptions of the menu. Further, the real-time content preview may allow for seamless collaboration between different stakeholders involved in menu management, such as chefs, marketers, and management, ensuring that the stakeholders have visibility into the final menu before the final menu is published.

FIG. 12 illustrates an immediate reflection of updates to content 1202 of a menu on the digital menu interface 1212 rendered on the client application on the customer's 1214 communication device 1210. Consider an example scenario where a user such as a restaurant operator or a content author updates content 1202 of the menu including a price of a food item, for example, a burger, on a user device 1200 such as a laptop. For example, the user may update the price of the burger to $18.50. In a variety of embodiments, when the user updates any content 1202 of the menu, the menu management system may compress the updated content 1202 and transmit the compressed content 1204 to a cloud storage system 1206 including one or more data stores. The cloud storage system 1206 may segment the compressed content 1204 into packets 1208 and transmit the packets 1208 to the customer's 1214 communication device 1210 in real time or near-real time. Upon receiving the transmitted packets 1208, the client application on the customer's 1214 communication device 1210 may render the updated content 1202 on the digital menu interface 1212. This streamlined transmission process may allow for updates to occur, for example, in less than 250 milliseconds, creating a nearly instantaneous experience for the customer 1214 and maintaining the responsiveness and reliability of the order processing system. By compressing the updated content 1202 and segmenting the updated content 1202 into small packets 1208, the menu management system, in operable communication with the cloud storage system 1206, may optimize the transfer of the updated content 1202 to the digital menu interface 1212, minimizing latency and ensuring that the updates are delivered swiftly to the customer 1214. This real-time or near-real-time transmission of the updated content 1202 may enhance the customer experience, enabling the customer 1214 to access the latest menu offerings and pricing without any noticeable delays.

In the above example scenario, the customer 1214 may view a menu of a restaurant on the digital menu interface 1212 and see the updated content 1202, that is, the burger priced at $18.50, complete with an updated description and options for customization. This real-time content preview, where updates to the menu are seamlessly and rapidly communicated to the customer 1214, may ensure that the customer experience aligns with the user's intentions, allowing the customer 1214 to make informed decisions and providing confidence that the menu accurately reflects the restaurant's offerings. Moreover, the speed at which these updates are transmitted to the client application on the customer's 1214 communication device 1210 may create a seamless and responsive ordering experience, enhancing customer satisfaction and confidence in a digital platform of the restaurant. Furthermore, the rapid transmission of the updated content 1202 via the cloud storage system 1206 may facilitate enhanced collaboration and communication between different stakeholders involved in menu management. The users can update the content of the menu in real-time, knowing that updates will be promptly disseminated to the client application installed on communication devices of customers, thereby allowing restaurants to respond quickly to changing market conditions, seasonal trends, or inventory availability, ensuring that the menu remains relevant and up-to-date. The real-time data sharing may, therefore, enhance the agility and responsiveness of restaurant operations. By ensuring that the updates to the content of the menu are instantly propagated to the digital menu interface 1212, staff at the restaurant can quickly adapt to changes in inventory, seasonal offerings, or pricing adjustments. This agility may allow restaurants to stay competitive in a fast-paced industry and respond effectively to evolving customer preferences and market trends.

In various embodiments, the menu management system may provide a unified solution for creating and managing digital menus. In more embodiments, the menu management system may implement a Menu Definition Language (MDL) to facilitate the creation and management of digital menus. The MDL may refer to a domain-specific language or a structured format configured to define a layout, structure, behavior, and logic of digital menus in software applications, for example, for embedded systems, graphical user interfaces, mobile apps, web interfaces, or the like. In additional embodiments, the menu management system may utilize the MDL to create digital menus by mirroring the structure and language of conventional menus, allowing users with minimal technical knowledge to effortlessly craft mobile-friendly versions of the digital menus. The MDL may implement an intuitive design to allow the users to replicate natural language constructs such as bulleted lists and customizable modifiers, streamlining tasks and reducing their complexity. Moreover, the MDL may support diverse input methods, ensuring accessibility and efficiency across various content creation modalities.

In further embodiments, the MDL may define menu items such as labels, buttons, or checkboxes; a hierarchical structure such as submenus, parent/child relationships, or the like; navigation rules defining how customers may move between dining items; actions triggered by selections; visibility/enablement conditions; styling and localization, or like. The MDL may define the menu items by utilizing, for example, custom scripts, an extensible Markup Language (XML) format, a JavaScript Object Notation (JSON), YAML Ain't Markup Language (YAML), or other structured text formats.

In still more embodiments, the menu management system may receive at least two versions of a menu of a dining entity, identify at least one difference between the received versions of the menu of the dining entity, and update the digital menu interface based on the identified difference(s). In still additional embodiments, the menu management system may execute a comparative analysis functionality implemented by the MDL for the identification of the difference(s) between the received versions of the menu of the dining entity. In still further embodiment, the comparative analysis functionality may include a hash-based comparison where each menu configuration can be hashed, where a change in a hash of the menu configuration may indicate the difference(s). In some more embodiments, the comparative analysis functionality may include a semantic comparison of functional changes such as changes in an action of an interface element, user interface logic changes, or the like, to indicate the difference(s). In still additional embodiments, the comparative analysis functionality may utilize versioning tags to track changes in the received versions of the menu. In yet various embodiments, the comparative analysis functionality may compare serialized MDL files by utilizing tools to detect added, removed, or modified menu items and to track changes in labels, actions, hierarchy, or the like. The comparative analysis functionality may allow dining entities to tailor their offerings across different service channels or adapt their digital menus dynamically in response to market demands. By automating the versioning process, the MDL may ensure that digital menus remain current and contextually relevant, enhancing both the dining experience for the customers and operational workflows for the dining entities.

Although a specific embodiment for an instantaneous update of content of a menu on a digital menu interface 1212 suitable for carrying out the various steps, processes, methods, and operations described herein is discussed with respect to FIG. 12, any of a variety of systems and/or processes may be utilized in accordance with embodiments of the disclosure. For example, in addition or alternative to segmentation, the menu management system may utilize other methods for instantaneously updating the content of the menu on the digital menu interface 1212 in real time or near-real time. In yet more embodiments, the order processing system may implement a communication protocol to provide a persistent two-way communication channel between the client application and the order processing system over a single Transmission Control Protocol (TCP) connection for a real-time exchange of updated content between the client application and the order processing system, without the need for the client application to continuously request for the updated content from the order processing system. The elements depicted in FIG. 12 may also be interchangeable with other elements of FIGS. 1-11 and FIGS. 13-17 as required to realize a particularly desired embodiment.

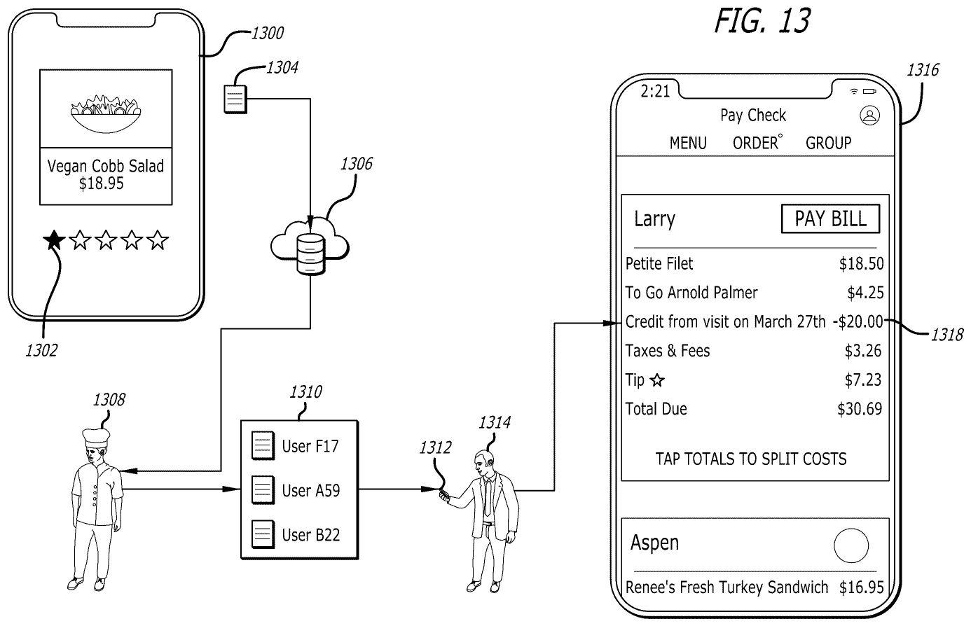

Referring to FIG. 13, a schematic diagram illustrating customer remediation through digital credits in accordance with various embodiments of the disclosure is shown. In the competitive landscape of the dining industry, maintaining customer satisfaction is paramount to success of dining entities, for example, restaurants. In many embodiments, an order processing system associated with a dining entity may implement customer remediation to address customer dissatisfaction via digital credits. In instances where customers express dissatisfaction or provide feedback about a poor experience or food item, for example, by providing a low rating 1302 for the food item via a communication device 1300, management at the dining entity may utilize the digital credits generated by the order processing system to respond proactively and remedy the situation, without the need for exchanging any personal information. This approach to customer remediation may provide a swift and discreet resolution to customer grievances, allowing the management to address issues in a timely manner and mitigate any potential negative impact on a relationship with the customer. By offering the digital credits as compensation, the dining entities may demonstrate a commitment to customer satisfaction and loyalty, reinforcing their brand reputation and encouraging continued patronage.

Moreover, the utilization of digital credits as a remediation tool may provide a level of convenience and flexibility for customers. Instead of conventional forms of compensation such as vouchers or coupons, the digital credits can be easily applied to future orders, providing customers with immediate value and incentivizing them to return to the dining entity. The order processing system may implement a seamless redemption process to allow the customers to redeem the digital credits, thereby enhancing the overall customer experience and encouraging repeat business. Further, the order processing system may maintain anonymity in the customer remediation process to ensure privacy and confidentiality for both customers and management. Without requiring customers to provide personal information, the order processing system may provide reassurance that feedback of the customers and the resulting customer remediation process remain confidential, preserving the customers' trust in the dining entity. Furthermore, through the anonymous customer remediation process, the order processing system may allow the management to address customer concerns without the risk of breaching privacy regulations or compromising customer confidentiality.

The embodiment depicted in FIG. 13 illustrates how digital credits can be utilized to address customer dissatisfaction in a discreet and effective manner. Customers, for example, group members, who participated in a collaborative order and may be dissatisfied with a dining item, for example, a food item, ordered from a dining entity may provide feedback with a low rating 1302 via a client application installed in each of their communication devices 1300. The client application may transmit the feedback 1304 to a cloud storage system 1306 via a communication network, for example, the Internet. The management 1308 of the dining entity may receive the feedback 1304 at a communication device 1312 from the cloud storage system 1306 via the communication network. In response to the feedback 1304, by utilizing a client application installed on the communication device 1312, the management 1308 can issue digital credits 1310 to the affected group members, for example, user F17, user A59, and user B22, providing them with a tangible gesture of goodwill and apology. In the above example scenario, each group member, for example, the group member 1314, may be alerted to the issued digital credit 1318 and receive and view the issued digital credit 1318 on a digital menu interface 1320 rendered by a client application on the communication device 1316. The group member 1314, in turn, can discreetly utilize the issued digital credit 1318 on any return visit, thereby providing the group member 1314 with a positive and hassle-free experience. In a number of embodiments, the digital credits issued to all the group members may be displayed on their respective sections on the digital menu interface 1320. The group members may view their issued digital credits on the digital menu interface 1320 rendered on their respective communication devices 1300.

Although a specific embodiment for customer remediation through digital credits suitable for carrying out the various steps, processes, methods, and operations described herein is discussed with respect to FIG. 13, any of a variety of systems and/or processes may be utilized in accordance with embodiments of the disclosure. For example, in addition or alternative to digital credits, the order processing system may provide other remediation measures such as providing a percentage discount of the entire bill associated with the collaborative order, providing a discount for individual dining items of individual group members who provided feedback with a low rating, providing service-level remediation by waiving delivery or service fees, or the like. The elements depicted in FIG. 13 may also be interchangeable with other elements of FIGS. 1-12 and FIGS. 14-17 as required to realize a particularly desired embodiment.

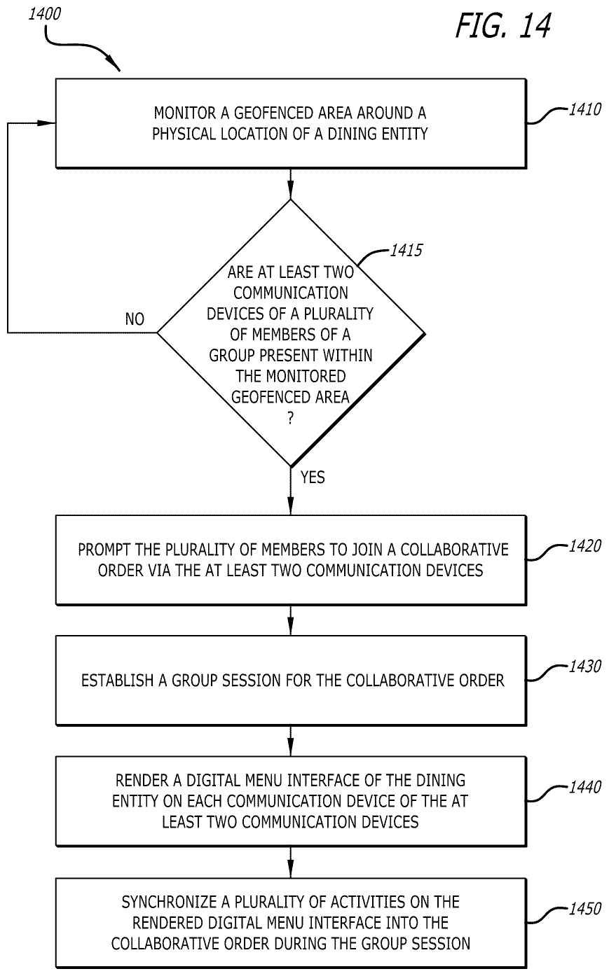

Referring to FIG. 14, a flowchart depicting a process 1400 for coordinating and processing a collaborative order in accordance with various embodiments of the disclosure is shown. In many embodiments, the process 1400 may implement geofencing technology for group dining scenarios, providing seamless coordination and processing of a collaborative order. Geofencing may allow dining entities to define geofences and create geofenced areas around their physical locations, thereby facilitating targeted interactions with members of a group based on their proximity. In a number of embodiments, the process 1400 may monitor a geofenced area around a physical location of a dining entity (block 1410). In a variety of embodiments, the process 1400 may facilitate creation of the geofenced area around the physical location of the dining entity by utilizing geofencing APIs, third-party geofencing platforms, SDKs, or the like. In various embodiments, the process 1400 may facilitate creation of the geofenced area around the physical location of the dining entity using location-based or proximity-based technologies such as GPS coordinates, a Wi-Fi® communication protocol, or a Bluetooth® communication protocol. In an example scenario, the process 1400 may facilitate creation of the geofenced area around a table of a dining entity, for example, a restaurant.

In more embodiments, the process 1400 may monitor and track a presence of communication devices of respective members of the group through a client application installed on each of the communication devices. To allow tracking of each of the communication devices, the client application may enable location services on each of the communication devices, provide permissions to track the location of each of the communication devices, and allow receipt of notifications, based on consent received from the members. In additional embodiments, when a communication device enters the geofenced area, the client application may detect this entry event using the GPS or network data of the communication device and transmit the entry event to an order processing system that implements the process 1400. The entry event may indicate the presence of the communication device within the geofenced area.

In further embodiments, the process 1400 may determine whether at least two communication devices of a plurality of members of a group are present within the monitored geofenced area (block 1415). The initiation of the collaborative order may require at least two communication devices of the members to be present within the monitored geofenced area. The collaborative order may refer to an order placed through cooperation and coordination between at least two members of the group. In still more embodiments, if the order processing system receives an entry event from at least two communication devices of the members, the process 1400 may determine their presence in the monitored geofenced area. In still further embodiments, in response to determining that at least two communication devices of the plurality of members of the group are not present within the monitored geofenced area, the process 1400 may reiterate the step of determining whether at least two communication devices of the plurality of members of the group are present within the monitored geofenced area (block 1415).

In still additional embodiments, in response to determining that at least two communication devices of the plurality of members of the group are present within the monitored geofenced area the process 1400 may prompt the plurality of members to join a collaborative order via the at least two communication devices (block 1420). In some more embodiments, the process 1400 may transmit notifications with a code or a link to the communication devices of the members. The code or the link may be associated with the collaborative order assigned to the group. In yet various embodiments, the process 1400 may transmit a push notification or message inviting each member to join the collaborative order.

In yet more embodiments, the process 1400 may establish a group session for the collaborative order (block 1430). The group session may refer to a coordinated, state-shared interaction between the members of the group via their communication devices within the collaborative order. The group session may include, for example, synchronous communication for ordering dining items from the dining entity, shared data, and group session membership management. In still yet more embodiments, the process 1400 may be establish the group session for the collaborative order based on an acceptance of the prompt on the communication devices. In many further embodiments, the prompt may include a code, for example, a numeric code, a multi-character code, an alphanumeric code, or the like, that may be utilized by the members to pair their communication devices to form the group and establish the group session. In many additional embodiments, the members may pair their respective communication devices via a client application hosted by an order processing system associated with the dining entity to form the group. In still yet further embodiments, the process 1400 may be establish the group session by utilizing real-time or near-real-time networking techniques. In still yet additional embodiments, once the group session is established, the process 1400 may store data associated with the established group session in a cloud storage system via a communication network, for example, the Internet. In several embodiments, the process 1400 may assign a unique session Identifier (ID), for example, a Universally Unique Identifier (UUID), a hash, or a human-readable code, that links the members to a correct instance of the group session.

In several more embodiments, the process 1400 may render a digital menu interface of the dining entity on each communication device of the at least two communication devices (block 1440). Once the group session is established, the process 1400 may generate a digital menu interface for the collaborative order and render the digital menu interface on the client application in each communication device. The digital menu interface may display a menu of the dining entity. The menu may include an itemized list of dining items, for example, food items, beverage items, or the like. The members of the group may access the menu on the digital menu interface rendered on their respective communication devices for performing multiple activities associated with the menu.

In numerous embodiments, the process 1400 may receive at least two versions of the menu of the dining entity. The process 1400 may identify at least one difference between the received versions of the menu of the dining entity. In numerous additional embodiments, the process 1400 may execute a comparative analysis functionality implemented by a menu definition language for the identification of the difference(s) between the received versions of the menu of the dining entity. The process 1400 may then update the digital menu interface based on the identified difference(s).

In further additional embodiments, the process 1400 may synchronize a plurality of activities on the rendered digital menu interface into the collaborative order during the group session (block 1450). The activities may include, for example, at least one of: selecting one or more dining items offered by the dining entity, modifying the dining item(s), issuing one or more requests, and executing one or more payments from the members of the group. In many embodiments, the process 1400 may render the dining items in a catalog format on corresponding dining cards on a menu section of the digital menu interface. In response to a selection of a dining item in the menu section, the process 1400 may expand and execute at least one customization on a dining card associated with the dining item on the digital menu interface, free of navigating away from the menu section. In a number of embodiments, the digital menu interface may include an order screen configured to integrate a set of dining items ordered by the members of the group during the group session and provide multiple customization options for the collaborative order.

In a variety of embodiments, the process 1400 may synchronize the activities on the rendered digital menu interface into the collaborative order during the group session in one of real time or near-real time. In various embodiments, the process 1400 may reflect an update of at least one activity instantaneously on the communication devices of the members of the group during the group session. In more embodiments, the process 1400 may store activity data of the activities in the cloud storage system during the group session. In additional embodiments, when a member of the group chooses to leave the group and in turn, the group session, the process 1400 may delete a subset of the activity data, that is, that member's activity data, from the cloud storage system based on that's member's communication device exiting the group session. The subset of the activity data may be associated with that member's communication device. In further embodiments, when a member chooses to join the group and in turn, the group session, the process 1400 may store that member's activity data in the cloud storage system. The cloud storage system may be configured to operate as a central hub for coordinating and synchronizing all activities and interactions between the members of the group via the client application installed on their respective communication devices.

Although a specific embodiment for a process 1400 for coordinating and processing a collaborative order suitable for carrying out the various steps, processes, methods, and operations described herein is discussed with respect to FIG. 14, any of a variety of systems and/or processes may be utilized in accordance with embodiments of the disclosure. For example, in still more embodiments, the process 1400 may execute AI models to generate recommendations for activities that may be performed by the members of the group, on the digital menu interface. The elements depicted in FIG. 14 may also be interchangeable with other elements of FIGS. 1-14 and FIGS. 15-17 as required to realize a particularly desired embodiment.

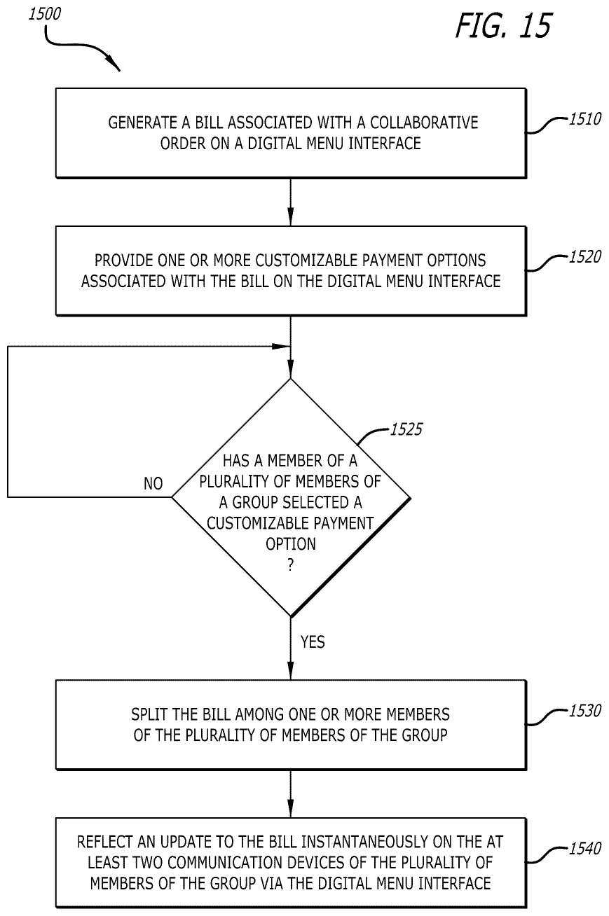

Referring to FIG. 15, a flowchart depicting a process 1500 for facilitating splitting of a bill associated with a collaborative order in accordance with various embodiments of the disclosure is shown. After members of a group complete placement of the collaborative order at a dining entity, for example, a restaurant, via their respective communication devices, the process 1500 may trigger a payment process. In many embodiments, the process 1500 may generate a bill associated with the collaborative order on a digital menu interface (block 1510). The process 1500 may display the bill via the digital menu interface rendered on the communication devices of respective members of the group. The process 1500 may itemize each member's bill, detailing the specific dining items the members have ordered, along with taxes, fees, and optional tips. In a number of embodiments, the process 1500 may display each member's bill on separate sections sequentially on the digital menu interface.

In a variety of embodiments, the process 1500 may provide one or more customizable payment options associated with the bill on the digital menu interface (block 1520). The customizable payment options may include, for example, splitting the bill equally or based on individual dining items ordered by each of the members. In various embodiments, the process 1500 may prompt each member to pay their own portion of the bill, reflecting the dining items they have individually ordered on respective sections of the digital menu interface, thereby enhancing the payment process by ensuring fairness and accuracy in splitting costs among the members. By implementing individual payments, the process 1500 may ensure that each member is responsible for their own costs on the bill, preventing any discrepancies or disputes over the bill. Either by adjusting tip amounts or reviewing detailed breakdowns of their costs, the process 1500 may provide the members with the flexibility to customize their payments according to their preferences, thereby enhancing the overall group experience and reinforcing a positive relationship between the members and the dining entity.

In more embodiments, the process 1500 may determine whether a member of the plurality of members of the group selected a customizable payment option (block 1525). In additional embodiments, the process 1500 may attach event listeners or event handlers to interface elements, for example, buttons, links, or the like, corresponding to the customizable payment options displayed on the digital menu interface. The process 1500 may determine whether a member of the group selected a customizable payment option by utilizing the event listeners. These event listeners may monitor for specific input events, for example, taps, clicks, selections, etc., and trigger corresponding callback functions in a computer program code of the client application when the input event occurs. In further embodiments, in response to determining that a member of the plurality of members of the group did not select a customizable payment option, the process 1500 may reiterate the step of determining whether a member of the plurality of members of the group selected a customizable payment option (block 1525).

In still more embodiments, in response to determining that a member of a plurality of members of a group selected a customizable payment option, the process 1500 may split the bill among one or more members of the plurality of members of the group (block 1530). In still further embodiments, the process 1500 may split the bill among one or more members of the group based on a selection of the customizable payment option. Instead of having to manually calculate and divide the bill among multiple members, the process 1500 may allow each member to tap totals on the bill rendered on the digital menu interface to split costs directly from their communication devices, thereby streamlining the payment process, saving time and effort for the members. The process 1500 may automatically track each member's share of the total cost and display updated totals instantly on each member's communication device 600 in real time or near-real time, allowing each member to pay their updated totals quickly without confusion.

In still additional embodiments, the process 1500 may reflect an update to the bill instantaneously on the at least two communication devices of the plurality of members of the group via the digital menu interface (block 1540). The process 1500 may reflect an update to the bill instantaneously on the communication devices of the members of the group via the digital menu interface based on the split. As dining items are added to the bill or changes are made, the process 1500 may immediately reflect these changes on each member's communication device, ensuring transparency and accuracy in the payment process. In some more embodiments, the process 1500 may immediately reflect payment arrangements on the communication devices of the members. As the members initiate splitting of payments, the process 1500 may instantly update and display changes on the respective digital menu interfaces, providing real-time visibility into the payment status for the members. This transparency may ensure that all the members are aware of their respective contributions and facilitate seamless coordination within the group.

Although a specific embodiment for a process 1500 for facilitating splitting of a bill associated with a collaborative order suitable for carrying out the various steps, processes, methods, and operations described herein is discussed with respect to FIG. 15, any of a variety of systems and/or processes may be utilized in accordance with embodiments of the disclosure. For example, in yet various embodiments, the process 1500 may execute one or more AI models for predicting suitable splits of the bill between members of the group during the group session. The elements depicted in FIG. 15 may also be interchangeable with other elements of FIGS. 1-14 and FIGS. 16-17 as required to realize a particularly desired embodiment.

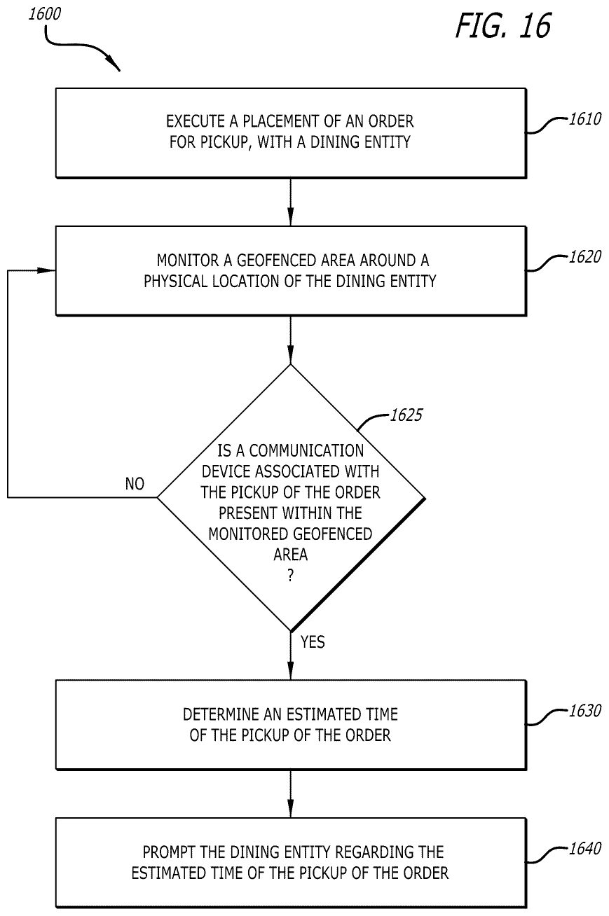

Referring to FIG. 16, a flowchart depicting a process 1600 for facilitating a completion of an order based on an estimated time of a pickup of the order in accordance with various embodiments of the disclosure is shown. In many embodiments, the process 1600 may leverage geofencing to optimize order pickup arrangements, enhancing convenience and efficiency for an individual user, a group designate, delivery personnel, or the like, herein referred to as “customer.” The process 1600 may synchronize the timing of readiness of the order with proximity of the customer's communication device to a dining entity, for example, a restaurant, to minimize wait times and ensure that dining items in the order are served fresh and promptly upon arrival of the customer.

In a number of embodiments, the process 1600 may execute a placement of an order for pickup, with a dining entity (block 1610). The order may, for example, be a collaborative order, placed through cooperation and coordination between at least two members of a group. The order for pickup may be placed via a digital menu interface rendered by a client application installed on a communication device of each member of the group. The process 1600 may execute the placement of the order for pickup based on various activities performed by the members of the group on the digital menu interface accessible on their respective communication devices. The activities may include, for example, adding, removing, copying, or changing dining items of the collaborative order via the digital menu interface. The order may be picked up at the dining entity by a group designate. In a variety of embodiments, the order may also be an individual order for pickup by an individual customer or delivery personnel.

In various embodiments, the process 1600 may monitor a geofenced area around a physical location of the dining entity (block 1620). In more embodiments, the process 1600 may facilitate creation of the geofenced area around the physical location of the dining entity by utilizing geofencing APIs, third-party geofencing platforms, SDKs, or the like. In additional embodiments, the process 1600 may facilitate creation of the geofenced area around the physical location of the dining entity using location-based or proximity-based technologies such as GPS coordinates, a Wi-Fi® communication protocol, or a Bluetooth® communication protocol. In further embodiments, the process 1600 may monitor and track a presence of the communication device of the customer through a client application installed on the customer's communication device. To allow tracking of the customer's communication device, the client application may enable location services on the communication device, provide permissions to track the location of the communication device, and allow receipt of notifications, based on consent received from the customer.

In additional embodiments, the process 1600 may determine whether a communication device associated with the pickup of the order is present within the monitored geofenced area (block 1625). In some more embodiments, when the communication device enters the monitored geofenced area, the client application may detect this entry event using the GPS or network data of the communication device and transmit the entry event to an order processing system that implements the process 1600. The entry event may indicate the presence of the communication device within the geofenced area. The process 1600 may determine whether the communication device associated with the pickup of the order is present within the monitored geofenced area based on the entry event. In still more embodiments, in response to determining that the communication device associated with the pickup of the order is not present within the monitored geofenced area, the process 1600 may reiterate the step of monitoring the geofenced area around the physical location of the dining entity (block 1620).

In still further embodiments, in response to determining that the communication device associated with the pickup of the order is present within the monitored geofenced area, the process 1600 may determine an estimated time of the pickup of the order (block 1630). In still additional embodiments, when the communication device associated with the pickup of the order is present within the monitored geofenced area, the process 1600 may trigger a notification to an order processing system of the dining entity. With permission, the process 1600 may then obtain real-time GPS coordinates of the communication device for fetching the real-time location of the communication device. The process 1600 may then determine a distance of the communication device to the dining entity by utilizing, for example, a Haversine formula or a mapping API. The process 1600 may then estimate a travel time by utilizing, for example, a distance to time conversion or a routing API.

In some more embodiments, the process 1600 may prompt the dining entity regarding the estimated time of the pickup of the order (block 1640). For example, process 1600 may prompt the dining entity to initiate or complete preparation of the order based on the estimated time of the pickup of the order. By synchronizing the timing of readiness of the order with the proximity of the customer's communication device 212 to the dining entity, the process 1600 may minimize wait times and ensure that the dining items are served fresh and promptly upon arrival of the customer. By allowing the dining entity to synchronize a timing of a preparation or a completion of the order with an actual time of arrival of the customer for the pickup of the order, the dining entity can maintain the intended temperature, texture, or freshness of the dining items by the time the customer arrives, resulting in increased customer satisfaction. Further, the increased visibility into the estimated time of the pickup of the order may reduce delays in the preparation of the dining items and bottlenecks, particularly during peak hours at the dining entity, thereby optimizing coordination and processing of orders and other areas of restaurant operations, including dine-in and other takeout services. In yet various embodiments, once the order is placed and prepared, the process 1600 may automatically trigger notifications associated with the pickup of the order to the customer's communication device based on the estimated time of the pickup. In yet more embodiments, once the order is placed and prepared, the process 1600 may automatically trigger notifications associated with the pickup of the order to the customer's communication device as they traverse the geofenced area of the dining entity, prompting the customer, via their communication device, to proceed to a designated pickup area.

Although a specific embodiment for a process 1600 for facilitating a completion of an order based on an estimated time of a pickup of the order suitable for carrying out the various steps, processes, methods, and operations described herein is discussed with respect to FIG. 16, any of a variety of systems and/or processes may be utilized in accordance with embodiments of the disclosure. For example, in still yet more embodiments, the process 1600 may execute predictive AI models with historical order data and pickup data to predict an estimated time of a pickup of the order. In many further embodiments, the process 1600 may execute AI models to coordinate order preparation timing at a kitchen of the dining entity to ensure the order is completed just before the customer arrives. The elements depicted in FIG. 16 may also be interchangeable with other elements of FIGS. 1-15 and FIG. 17 as required to realize a particularly desired embodiment.

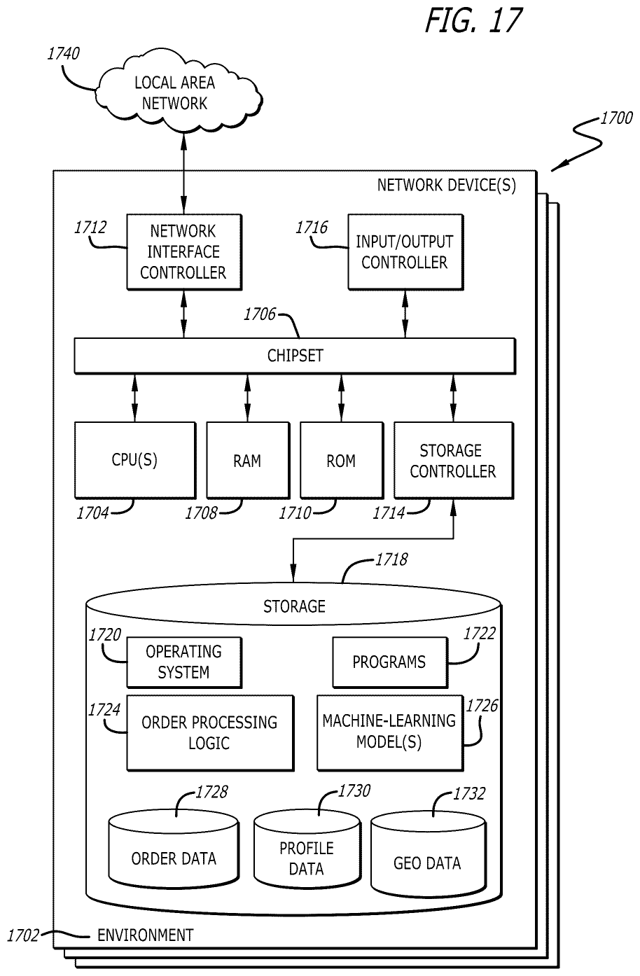

Referring to FIG. 17, a conceptual block diagram of a system 1700 suitable for configuration with an order processing logic 1724 for implementing the functionality and various embodiments of the disclosure is shown. The embodiment of the system 1700 in the conceptual block diagram depicted in FIG. 17 may relate to a conventional server computer, a workstation, a desktop computer, a laptop, a tablet, a network appliance, an electronic reader (e-reader), a smartphone, or other computing device, and can be utilized to execute any of the applications and/or logic components described herein. The system 1700 may, in some examples, correspond to a physical device or to a virtual resource described herein. The system 1700 can be an order processing system, an advanced digital payment system, a personalized recommendation system, a menu management system, or the like in accordance with various embodiments of the disclosure.

In many embodiments, the system 1700 may include an environment 1702 such as a baseboard or a “motherboard,” in physical embodiments that can be configured as a printed circuit board with a multitude of components or devices connected by way of a system bus or other electrical communication paths. Conceptually, in virtualized embodiments, the environment 1702 may be a virtual environment that encompasses and executes the remaining components and resources of the system 1700. In a number of embodiments, one or more processors 1704 such as, but not limited to, Central Processing Units (denoted as “CPUs 1704”), can be configured to operate in conjunction with a chipset 1706. The processor(s) 1704 can be standard programmable CPUs that perform arithmetic and logical operations necessary for the operation of the system 1700.

In a variety of embodiments, the processor(s) 1704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, or the like.

In various embodiments, the chipset 1706 may provide an interface between the processor(s) 1704 and the remainder of the components and devices within the environment 1702. The chipset 1706 can provide an interface to a RAM 1708, which can be utilized as the main memory in the system 1700 in some embodiments. The chipset 1706 can further be configured to provide an interface to a computer-readable storage medium such as a ROM 1710 or a Non-Volatile RAM (NVRAM) for storing basic routines that can help with various tasks such as, but not limited to, starting up the system 1700 and/or transferring information between the various components and devices. The ROM 1710 or NVRAM can also store other application components necessary for the operation of the system 1700 in accordance with various embodiments described herein.

Different embodiments of the system 1700 can be configured to operate in a networked environment using logical connections to remote computing devices and computer systems through a network, such as the network 1740 (shown as “Local Area Network 1740”). The chipset 1706 can include functionality for providing network connectivity through a Network Interface Controller (NIC) 1712, which may include a gigabit Ethernet adapter or similar component. The NIC 1712 can be capable of connecting the system 1700 to other devices over the network 1740. It is contemplated that multiple NICs 1712 may be present in the system 1700, connecting the system 1700 to other types of networks and remote systems.

In more embodiments, the system 1700 can be connected to a storage 1718 that provides non-volatile storage for data accessible by the system 1700. The storage 1718 can, for example, store an operating system 1720, applications or programs 1722, order data 1728, profile data 1730, and geo data 1732, which are described in greater detail below. The storage 1718 can be connected to the environment 1702 through a storage controller 1714 connected to the chipset 1706. In additional embodiments, the storage 1718 can include one or more physical storage units. The storage controller 1714 can interface with the physical storage units through a Serial Advanced Technology Attachment (SATA) interface, a Fiber Channel (FC) interface, a Serial Attached SCSI (SAS) interface, where SCSI refers to a Small Computer System Interface, or other type of interface for physically connecting and transferring data between computers and physical storage units.

The system 1700 can store data within the storage 1718 by transforming the physical state of the physical storage units to reflect the information being stored. The specific transformation of the physical state can depend on various factors. Examples of such factors can include, but are not limited to, the technology utilized to implement the physical storage units, whether the storage 1718 is characterized as primary or secondary storage, and the like. For example, the system 1700 can store information within the storage 1718 by issuing instructions through the storage controller 1714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The system 1700 can further read or access information from the storage 1718 by detecting the physical states or characteristics of one or more particular locations within the physical storage units.

In addition to the storage 1718 described above, the system 1700 can have access to other computer-readable storage media to store and retrieve information, such as program modules, data structures, or other data. It should be appreciated by those skilled in the art that computer-readable storage media is any available media that provides for the non-transitory storage of data and that can be accessed by the system 1700. In some examples, the operations performed by a cloud computing network, and or any components included therein, may be supported by one or more devices similar to the system 1700. Stated otherwise, some or all of the operations performed by the cloud computing network, and or any components included therein, may be performed by the system 1700 operating in a cloud-based arrangement.

By way of example, and not limitation, computer-readable storage media can include volatile, non-volatile, removable, and non-removable media implemented in any method or technology. Computer-readable storage media includes, but is not limited to, RAM, ROM, Erasable Programmable ROM (EPROM), Electrically-Erasable Programmable ROM (EEPROM), flash memory or other solid-state memory technology, Compact Disc-ROM (CD-ROM), Digital Versatile Disk (DVD), High Definition DVD (HD-DVD), BLU-RAY, or other optical storage, magnetic cassettes, magnetic tape, magnetic disk storage or other magnetic storage devices, or any other medium that can be utilized to store the desired information in a non-transitory fashion.

As mentioned briefly above, the storage 1718 can store an operating system 1720 utilized to control the operation of the system 1700. According to numerous embodiments, the operating system 1720 includes the LINUX operating system. According to several embodiments, the operating system 1720 includes the Windows® server operating system from Microsoft Corporation of Redmond, Washington. According to further embodiments, the operating system 1720 can include the UNIX operating system or one of its variants. It should be appreciated that other operating systems can also be utilized. The storage 1718 can store other system or application programs and data utilized by the system 1700.

In still more embodiments, the storage 1718 or other computer-readable storage media is encoded with computer-executable instructions which, when loaded into the system 1700, may transform the system 1700 from a general-purpose computing system into a special-purpose computer capable of implementing the embodiments described herein. These computer-executable instructions may be stored as applications or programs 1722 and transform the system 1700 by specifying how the processor(s) 1704 can transition between states, as described above. In still further embodiments, the system 1700 has access to computer-readable storage media storing computer-executable instructions which, when executed by the system 1700, perform the various processes described above with regard to FIGS. 1-16. In still additional embodiments, the system 1700 can also include computer-readable storage media having instructions stored thereupon for performing any of the other computer-implemented operations described herein.

In some more embodiments, the system 1700 can also include one or more input/output controllers 1716 for receiving and processing input from a number of input devices, such as a keyboard, a mouse, a touchpad, a touch screen, an electronic stylus, or other type of input device. Similarly, an input/output controller 1716 can be configured to provide output to a display, such as a computer monitor, a flat panel display, a digital projector, a printer, or other type of output device. Those skilled in the art will recognize that the system 1700 may not include all of the components shown in FIG. 17, and can include other components that are not explicitly shown in FIG. 17, or may utilize an architecture completely different than that shown in FIG. 17.

As described above, the system 1700 may support a virtualization layer, such as one or more virtual resources executing on the system 1700. In some examples, the virtualization layer may be supported by a hypervisor that provides one or more virtual machines running on the system 1700 to perform functions described herein. The virtualization layer may generally support a virtual resource that performs at least a portion of the techniques described herein.

In yet various embodiments, the system 1700 can include an order processing logic 1724 that may be responsible for coordinating and processing a collaborative order. In yet more embodiments, the order processing logic 1724 may operate in an automation system. In embodiments where the system 1700 corresponds to the order processing system, the order processing logic 1724 can be configured to perform various operations such as, but not limited to, monitoring a geofenced area around a physical location of a dining entity; in response to a presence of at least two communication devices of a plurality of members of a group within the monitored geofenced area, prompt the plurality of members to join a collaborative order via the at least two communication devices; establish a group session for the collaborative order based on an acceptance of the prompt on the at least two communication devices; render a digital menu interface of the dining entity on each communication device of the at least two communication devices; and synchronize a plurality of activities on the rendered digital menu interface into the collaborative order during the group session.

In numerous embodiments where the system 1700 corresponds to the order processing system, the order processing logic 1724 can be configured to perform various operations such as, but not limited to, generating a bill associated with the collaborative order on the digital menu interface; providing one or more customizable payment options associated with the bill on the digital menu interface; splitting the bill among one or more members of the plurality of members of the group based on a selection of a customizable payment option of the one or more customizable payment options; and reflecting an update to the bill instantaneously on the at least two communication devices of the plurality of members of the group via the digital menu interface based on the split. In still yet more embodiments where the system 1700 corresponds to the order processing system, the order processing logic 1724 can be configured to perform various operations such as, but not limited to, executing a placement of an order for pickup, with a dining entity; monitoring a geofenced area around a physical location of the dining entity; determining an estimated time of the pickup of the order in response to a presence of a communication device associated with the pickup of the order within the monitored geofenced area; and prompting the dining entity regarding the estimated time of the pickup of the order.

Those skilled in the art will recognize that the order processing logic 1724 can include various hardware and/or software deployments and can be configured in a variety of ways. In many additional embodiments, the order processing logic 1724 can be configured as a standalone device, exist as a logic in another device, be distributed among various devices operating in tandem, or remotely operated as part of a cloud-based management tool. In still yet further embodiments, one or more servers can be configured with the order processing logic 1724 or can otherwise operate as the order processing logic 1724. In still yet additional embodiments, the order processing logic 1724 may operate on one or more servers connected to a communication network, for example, the Internet. The communication network can include wired networks or wireless networks. The order processing logic 1724 can be provided as a cloud-based service that can service remote networks, such as, but not limited to, a deployed network. Further, in several embodiments, the order processing logic 1724 may be operated as a distributed logic across multiple devices. In an embodiment, the controller can operate as the order processing logic 1724 or may have multiple devices operate as the order processing logic 1724 in a distributed manner. In yet more embodiments, the order processing logic 1724 may be a client application that resides on a network-connected device, such as, but not limited to, a server, a personal or mobile computing device in a single or distributed arrangement. In still yet more embodiments, the order processing logic 1724 can be a dedicated hardware device or be configured into a System-on-a-Chip (SoC) package, for example, a Field-Programmable Gate Array (FPGA), Application-Specific Integrated Circuit (ASIC), or the like.

In several more embodiments, the storage 1718 can include order data 1728. The order data 1728 may relate to data representative of an order, for example, a collaborative order placed and executed during a group session. The order data 1728 may include a comprehensive set of information related to one or more orders and transactions. For example, the order data 1728 may include details such as dining items selected by a customer, their quantities, and any customizations or special instructions. The order data 1728 may also include, for example, information about the customer or members of a group placing the order, for example, their names, contact information, and delivery or pickup preferences. Transaction-related data including, for example, billing information, payment methods, payment splits, total amount paid, any applicable taxes or fees, or the like may also constitute the order data 1728. Furthermore, the order data 1728 may encompass timestamps indicating when the order was placed, confirmed, and fulfilled, providing insights into the order's lifecycle and processing status.

In numerous additional embodiments, the storage 1718 can include profile data 1730. The profile data 1730 may relate to data representative of a preference profile of the customer or members of the group. The profile data 1730 may include, for example, data associated with a social circle of the customer or the members of the group, location data, time, one or more social influencing elements, a reputation, a rating, one or more preferences, one or more behavioral elements, order data associated with the order, activity data associated with activities performed on a digital menu interface, one or more reviews, one or more events, or one or more attractions proximal to the dining entity. In further additional embodiments, the profile data 1050 may include, for example, customer or group member data, location data, preferences, behavioral elements, historical order data, historical activity data associated with one or more activities performed on a digital menu interface, or the like.

In a variety of embodiments, the storage 1718 can include geo data 1732. The geo data 1732 may relate to data representative of a range of location-based information required for facilitating and optimizing the ordering process. The geo data may include precise geographic coordinates of both the customer's location and the dining entity's location, allowing the system 1700 to calculate the distance between them accurately. Moreover, the geo data 1732 may include details about the customer's current location, for example, street address, city, and postal code, providing context for routing the order to the nearest restaurant branch or pickup location. Furthermore, the geo data 332 may incorporate data associated with real-time updates on traffic conditions, road closures, or other factors that could impact the delivery or pickup process, enabling the system 1700 to dynamically adjust order routing and estimated delivery times accordingly.

In further embodiments, the storage 1718 can further include product data encompassing a wide range of information related to the dining items available for purchase on the digital menu interface. In these embodiments, the product data may include, for example, details such as name and description of each dining item, providing customers with a clear understanding of what they are ordering. Moreover, the product data may include pricing information, allowing customers to make informed decisions based on the cost of each dining item. The product data may further include ingredients and nutritional information of the dining items, catering to customers with specific dietary preferences or restrictions. Furthermore, the product data may encompass images or visuals of the dining items, enhancing the presentation and appeal of the offerings to customers browsing a digital menu. The product data serves as a comprehensive repository of information about offerings of the dining entity, enabling customers to browse, select, and order items with confidence and clarity.

In various embodiments, the data may be processed into a format usable by a Machine Learning (ML) model(s) 1726 (e.g., feature vectors), and/or other pre-processing techniques. The ML model(s) 1726 may be any type of ML model(s), such as supervised models, reinforcement models, and/or unsupervised models. The ML model(s) 1726 may include one or more of linear regression models, logistic regression models, decision trees, Naïve Bayes models, neural networks, k-means cluster models, random forest models, and/or other types of ML models. In more embodiments, the ML model(s) 1726 may be configured to dynamically generating at least one personalized dining recommendation based on the profile data of the customer. In additional embodiments, the ML model(s) 1726 may be configured to analyze the order data 1728, the profile data 1730, and the geo data 1732 to extract relevant indications and identifiers for coordinating and processing a collaborative order.

The ML model(s) 1726 can be configured to generate inferences to make predictions or draw conclusions from data. An inference can be considered the output of a process of applying a model to new data. This can occur by learning from at least the order data 1728, the profile data 1730, and the geo data 1732. These predictions are based on patterns and relationships discovered within the data. To generate an inference, the trained model can take input data and produce a classification result. The input data can be in various forms, such as text, numerical data, or order data 1728 depending on the type of problem the model was trained to solve. The output of the model can also vary depending on the problem, and can be a single number, a probability distribution, a set of labels, a decision about an action to take, etc. Ground truth for the ML model(s) 1726 may be generated by human/administrator verifications or may compare predicted outcomes with actual outcomes. Further, the ML model(s) 1726 may be configured to predict an estimated time of a pickup of an order based on the order data 1728, the profile data 1730, and the geo data 1732. For example, the ML model(s) 1726 may examine the order data 1728, the profile data 1730, and the geo data 1732 for estimating the time of the pickup of the order. By learning from the profile data 1730, the ML model(s) 1726 can generate personalized dining recommendations for the customer. In other words, once trained, the ML model(s) 1726 may be further deployed on the system 1700, for example, the order processing system, the menu management system, the personalized recommendation system, the advanced digital payment system, or the like, for coordinating and processing a collaborative order.

Although a specific embodiment for a system 1700 suitable for configuration with an order processing logic 1724 for carrying out the various steps, processes, methods, and operations described herein is discussed with respect to FIG. 17, any of a variety of systems and/or processes may be utilized in accordance with embodiments of the disclosure. For example, the device may be implemented in a virtual environment such as a cloud-based network administration suite or a cloud computing environment, or the device may be distributed across a variety of network devices such that each acts as a device and the order processing logic 1724 acts in tandem between the devices. The elements depicted in FIG. 17 may also be interchangeable with other elements of FIGS. 1-16 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous,” “exemplary,” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described embodiments and additional embodiments as regarded by those of ordinary skill in the art are hereby expressly incorporated by reference and are intended to be encompassed by the present claims.

Moreover, no requirement exists for a system or a method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as may be apparent to those of ordinary skill in the art, are also encompassed by the present disclosure.

What is claimed is:

1. A system, comprising:
one or more processors; and
a memory communicatively coupled to the one or more processors, wherein the memory comprises an order processing logic that is configured to:
monitor a geofenced area around a physical location of a dining entity;
in response to a presence of at least two communication devices of a plurality of members of a group within the monitored geofenced area, prompt the plurality of members to join a collaborative order via the at least two communication devices;
establish a group session for the collaborative order based on an acceptance of the prompt on the at least two communication devices;
render a digital menu interface of the dining entity on each communication device of the at least two communication devices; and
synchronize a plurality of activities on the rendered digital menu interface into the collaborative order during the group session.

2. The system of claim 1, wherein the order processing logic is further configured to:
receive at least two versions of a menu of the dining entity;
identify at least one difference between the received at least two versions of the menu of the dining entity; and
update the digital menu interface based on the identified at least one difference.

3. The system of claim 2, wherein the order processing logic is further configured to execute a comparative analysis functionality implemented by a menu definition language for the identification of the at least one difference between the received at least two versions of the menu of the dining entity.

4. The system of claim 1, wherein the order processing logic is further configured to render a plurality of dining items in a catalog format on corresponding dining cards on a menu section of the digital menu interface.

5. The system of claim 4, wherein, in response to a selection of a dining item of the plurality of dining items in the menu section, the order processing logic is further configured to expand and execute at least one customization on a dining card associated with the dining item on the digital menu interface, free of navigating away from the menu section.

6. The system of claim 1, wherein the digital menu interface comprises an order screen configured to integrate a set of dining items ordered by the plurality of members of the group during the group session and provide a plurality of customization options for the collaborative order.

7. The system of claim 1, wherein the plurality of activities comprises at least one of: selecting one or more dining items offered by the dining entity, modifying the one or more dining items, issuing one or more requests, and executing one or more payments from the plurality of members of the group.

8. The system of claim 1, wherein the order processing logic is further configured to reflect an update of at least one activity of the plurality of activities instantaneously on the at least two communication devices of the plurality of members of the group during the group session.

9. The system of claim 1, wherein the synchronization of the plurality of activities on the rendered digital menu interface into the collaborative order during the group session is in one of real time or near-real time.

10. The system of claim 1, wherein the order processing logic is further configured to store activity data of the plurality of activities in a cloud storage system during the group session.

11. The system of claim 10, wherein the order processing logic is further configured to delete a subset of the activity data from the cloud storage system based on a communication device of the at least two communication devices exiting the group session, and wherein the subset of the activity data is associated with the communication device.

12. The system of claim 1, wherein the order processing logic is further configured to:
generate a bill associated with the collaborative order on the digital menu interface;
provide one or more customizable payment options associated with the bill on the digital menu interface;
split the bill among one or more members of the plurality of members of the group based on a selection of a customizable payment option of the one or more customizable payment options; and
reflect an update to the bill instantaneously on the at least two communication devices of the plurality of members of the group via the digital menu interface based on the split.

13. The system of claim 1, wherein the order processing logic is further configured to transmit at least one promotional element to the at least two communication devices of the plurality of members of the group based on configurable criteria.

14. The system of claim 13, wherein the configurable criteria comprise at least one of: geolocation data, one or more preferences, or one or more behavioral elements of the plurality of members of the group.

15. The system of claim 1, wherein the order processing logic is further configured to:
generate a preference profile of at least one member of the plurality of members of the group; and
dynamically generate at least one personalized dining recommendation based on at least one of the preference profile or configurable criteria.

16. The system of claim 15, wherein the configurable criteria comprise at least one of: a social circle of the at least one member of the plurality of members of the group, location data, time, one or more social influencing elements, a reputation, a rating, one or more preferences, one or more behavioral elements, order data associated with the collaborative order, activity data associated with the plurality of activities on the rendered digital menu interface, one or more reviews, one or more events, or one or more attractions proximal to the dining entity.

17. The system of claim 1, wherein the order processing logic is further configured to render a compass element pointing to a line of sight associated with the physical location of the dining entity, on a graphical user interface of a communication device of the at least two communication devices in response to a presence of the communication device within the monitored geofenced area.

18. A system, comprising:
one or more processors; and
a memory communicatively coupled to the one or more processors, wherein the memory comprises an order processing logic that is configured to:
execute a placement of an order for pickup, with a dining entity;
monitor a geofenced area around a physical location of the dining entity;
determine an estimated time of the pickup of the order in response to a presence of a communication device associated with the pickup of the order within the monitored geofenced area; and
prompt the dining entity regarding the estimated time of the pickup of the order.

19. The system of claim 18, wherein the order processing logic is further configured to automatically trigger one or more notifications associated with the pickup of the order to the communication device based on the estimated time of the pickup.

20. A computer-implemented method, comprising:
monitoring a geofenced area around a physical location of a dining entity;
in response to a presence of at least two communication devices of a plurality of members of a group within the monitored geofenced area, prompting the plurality of members to join a collaborative order via the at least two communication devices;
establishing a group session for the collaborative order based on an acceptance of the prompt on the at least two communication devices;
rendering a digital menu interface of the dining entity on each communication device of the at least two communication devices; and
synchronizing a plurality of activities on the rendered digital menu interface into the collaborative order during the group session.
